(19) United States
(12) Patent Application Publication
(10) Pub. No.: US 2019/0140483 A1
(43) Pub. Date: May 9, 2019

(54) POWER TRANSMISSION DEVICE AND NON-CONTACT POWER FEEDING SYSTEM

(71) Applicant: ROHM CO., LTD., Kyoto-shi (JP)

(72) Inventor: Yoshihiro IKEFUJI, Kyoto-shi (JP)

(21) Appl. No.: 16/006,207

(22) Filed: Jun. 12, 2018

(30) Foreign Application Priority Data
Jun. 13, 2017 (JP) 2017-115858
Jun. 4, 2018 (JP) 2018-106612

(51) Int. Cl. H02J 50/12; H02J 50/80; H02J 50/60; H04B 5/00

(52) U.S. Cl. CPC H02J 50/12; H04B 5/0037; H02J 50/60; H02J 50/80

(57) ABSTRACT

A power transmission device has first to nth transmission-side coils (where n is an integer of 2 or more), and can transmit electric power to a power reception device by magnetic resonance. Before performing power transmission operation, the power transmission device feeds an evaluation alternating-current signal to the first to nth transmission-side coils one after another to acquire from the power reception device, by communication, power-related information based on the electric power received by the power reception device meanwhile. Based on the power-related information acquired, the power transmission device selects a transmission-side coil to be used in power transmission operation.

### CROSS-REFERENCE TO RELATED APPLICATIONS

This nonprovisional application claims priority under 35 U.S.C. § 119(a) on Patent Application No. 2017-115858 filed in Japan on Jun. 13, 2017 and on Patent Application No. 2018-106612 filed in Japan on Jun. 4, 2018, the entire contents of which are hereby incorporated by reference.

### BACKGROUND OF THE INVENTION

### Field of the Invention

The present invention relates to a power transmission device and a non-contact power feeding system.

### Description of Related Art

As one type of proximity wireless communication, there is near field communication (NFC) using a carrier frequency of 13.56 MHz. On the other hand, there is proposed a technique for performing non-contact power feeding by magnetic resonance method utilizing a coil that is used for the NFC communication.

In non-contact power feeding utilizing magnetic resonance, a power transmission-side resonance circuit including a power transmission-side coil is disposed in a power feeding device, while a power reception-side resonance circuit including a power reception-side coil is disposed in an electronic device as a power receiving device, and resonance frequencies of the resonance circuits are set to a common reference frequency. Further, alternating current is supplied to the power transmission-side coil so that the power transmission-side coil generates alternating magnetic field having the reference frequency. Then, this alternating magnetic field propagates to the power reception-side resonance circuit that resonates at the reference frequency, and hence alternating current flows in the power reception-side coil. In other words, electric power is transmitted from the power transmission-side resonance circuit including the power transmission-side coil to the power reception-side resonance circuit including the power reception-side coil.

In addition, there is proposed a method for accurately detecting whether or not a foreign object is present using a plurality of power transmission-side coils (see Patent Document 1).

Patent Document 1: JP-A-2017-11954

When various shapes of coils can be used as the power reception-side coil disposed on the power receiving device, power transfer efficiency can change variously depending on the shape of the power reception-side coil. On the other hand, it is needless to say that improvement in power transfer efficiency is beneficial.

### SUMMARY OF THE INVENTION

Accordingly, it is an object of the present invention to provide a power transmission device and a non-contact power feeding system that can contribute to improvement in power transfer efficiency.

A first power transmission device according to the present invention, which is capable of communicating with a power reception device equipped with a power reception-side coil and capable of transmitting electric power to the power reception device by magnetic resonance method, includes first to nth power transmission-side coils having different shapes (where n is an integer of 2 or more), a power transmission circuit capable of feeding an alternating-current signal to one of the first to nth power transmission-side coils, and a control circuit capable of performing power transmission operation to feed a power transmission alternating-current signal from the power transmission circuit to a target power transmission-side coil selected from the first to nth power transmission-side coils. Before performing the power transmission operation, the control circuit controls the power transmission circuit to feed an evaluation alternating-current signal to the first to nth power transmission-side coils one after another, acquires power-related information based on the received powers by the power reception device when the evaluation alternating-current signal is fed to the first to nth power transmission-side coils, from the power reception device by communication, and selects the target power transmission-side coil from the first to nth power transmission-side coils based on the acquired power-related information.

Specifically, for example, in the first power transmission device, the power-related information preferably contains information that identifies a power transmission-side coil corresponding to a maximum received power among the first to nth received powers by the power reception device based on the feeding of the evaluation alternating-current signal to the first to nth power transmission-side coils.

In addition, for example, in the first power transmission device, before performing the power transmission operation, the control circuit preferably uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

In addition, for example, as to the first power transmission device, the difference of shape includes a difference of size among the first to nth power transmission-side coils.

A first non-contact power feeding system according to the present invention includes the first power transmission device and a power reception device equipped with a power reception-side coil, so that power transmission and reception can be performed by magnetic resonance method between the power transmission device and the power reception device.

In the first non-contact power feeding system, for example, the power reception device preferably includes a received power detection circuit arranged to detect the received powers by the power reception-side coil when the evaluation alternating-current signal is fed to the first to nth power transmission-side coils, one after another, and the power-related information is generated based on the detection result.

A second power transmission device according to the present invention, which is capable of communicating with a power reception device equipped with a power reception-side coil and capable of transmitting electric power to the power reception device by magnetic resonance method, includes first to nth power transmission-side coils having different shapes (where n is an integer of 2 or more), a power transmission circuit capable of feeding an alternating-current signal to one of the first to nth power transmission-side coils, and a control circuit capable of performing power transmission operation to feed a power transmission alternating-current signal from the power transmission circuit to a target power transmission-side coil selected from the first to nth power transmission-side coils. Before performing the power transmission operation, the control circuit acquires shape-related information based on shape of the power reception-side coil from the power reception device by communication, and selects the target power transmission-side coil from the first to nth power transmission-side coils based on the acquired shape-related information.

In the second power transmission device, for example, the control circuit is capable of selecting two or more power transmission-side coils as candidates of the target power transmission-side coil from the first to nth power transmission-side coils based on the shape-related information, and when the two or more power transmission-side coils are selected, the control circuit preferably controls the power transmission circuit to feed an evaluation alternating-current signal to the two or more power transmission-side coils one after another, acquires a power-related information based on the received powers by the power reception device when the evaluation alternating-current signal is fed to the two or more power transmission-side coils, from the power reception device by communication, and selects the target power transmission-side coil from the two or more power transmission-side coils based on the acquired power-related information.

In this case, in the second power transmission device, for example, the power-related information preferably contains information that identifies a power transmission-side coil corresponding to a maximum received power among two or more received powers by the power reception device based on feeding of the evaluation alternating-current signal to the two or more power transmission-side coils.

In addition, for example, in the second power transmission device, before performing the power transmission operation, the control circuit preferably uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

In addition, for example, as to the second power transmission device, the difference of shape includes a difference of size among the first to nth power transmission-side coils.

A second non-contact power feeding system according to the present invention includes the second power transmission device and a power reception device equipped with a power reception-side coil, so that power transmission and reception can be performed by magnetic resonance method between the power transmission device and the power reception device.

In the second non-contact power feeding system, for example, the power reception device preferably includes a storage unit that stores the shape-related information.

A third non-contact power feeding system according to the present invention includes the second power transmission device and a power reception device equipped with a power reception-side coil, so that power transmission and reception can be performed by magnetic resonance method between the power transmission device and the power reception device. The power reception device includes a storage unit that stores the shape-related information, and a received power detection circuit arranged to detect the received powers by the power reception-side coil when the evaluation alternating-current signal is fed to the two or more power transmission-side coils, one after another, and the power-related information is generated based on the detection result.

According to the present invention, it is possible to provide the power transmission device and the non-contact power feeding system that can contribute to improvement of power transfer efficiency.

### BRIEF DESCRIPTION OF THE DRAWINGS

FIGS. 1A and 1B are schematic external views of a power feeding device and an electronic device according to a first embodiment of the present invention.

FIG. 2 is a schematic internal structural diagram of the power feeding device and the electronic device according to the first embodiment of the present invention.

FIG. 3 is a schematic internal structural diagram of the power feeding device and the electronic device according to the first embodiment of the present invention.

FIG. 4 is a partial structural diagram of the power feeding device including an internal block diagram of an IC inside the power feeding device according to the first embodiment of the present invention.

FIG. 5 is a partial structural diagram of the electronic device including an internal block diagram of an IC inside the electronic device according to the first embodiment of the present invention.

FIG. 6 is a diagram illustrating a manner in which magnetic field intensity varies when NFC communication and power transfer are performed alternately.

FIG. 7 is a diagram illustrating a relationship among a power transmission circuit, a load detection circuit, and a resonance circuit in the power feeding device.

FIG. 8 is a waveform diagram showing a voltage drop by a sense resistor in the load detection circuit illustrated in FIG. 7.

FIGS. 9A and 9B are respectively a schematic external view and a schematic internal structural diagram of a foreign object according to the first embodiment of the present invention.

FIGS. 10A to 10F are diagrams illustrating examples of an antenna coil to be mounted in a non-contact IC card.

FIG. 11 is a diagram illustrating a manner in which a switch is provided to each resonance circuit of the power transmission device.

FIG. 12 is an explanatory diagram of first to nth connection states in the power feeding device.

FIG. 13 is an example of a detailed circuit diagram for realizing the first to nth connection states.

FIG. 14 is an operation flowchart of a foreign object detection process performed by the power feeding device.

FIGS. 15A to 15D are diagrams showing examples of positional relationship among a power feeding table, the electronic device, and the foreign object.

FIG. 16 is a diagram showing one positional relationship among the power feeding table, the electronic device, and the foreign object.

FIG. 17 is an operation flowchart of a target resonance circuit setting process and a cooperation process that are performed in cooperation by the power feeding device and the electronic device.

FIG. 18 is a diagram showing a manner in which a received power detection circuit is included in an NFC power receiving circuit.

FIG. 19 is a diagram for explaining signal communication between the power feeding device and the electronic device according to the first embodiment of the present invention.

FIG. 20 is a diagram showing a manner in which the NFC communication, the foreign object detection process, and the power transfer are performed in turn repeatedly according to the first embodiment of the present invention.

FIG. 21 is an operation flowchart of the power feeding device according to the first embodiment of the present invention.

FIG. 22 is an operation flowchart of the electronic device according to the first embodiment of the present invention.

FIGS. 23A and 23B are explanatory diagrams of a shape of a loop antenna assumed in a second embodiment of the present invention.

FIG. 24 is a positional relationship diagram between a power transmission-side coil and a power reception-side coil assumed in the second embodiment of the present invention.

FIG. 25 is an operation flowchart of the power feeding device according to the second embodiment of the present invention.

FIG. 26 is an operation flowchart of the electronic device according to the second embodiment of the present invention.

FIG. 27 is a flowchart for explaining an operation according to a third embodiment of the present invention.

FIG. 28 is a diagram showing a layout example of an antenna pattern according to a fourth embodiment of the present invention.

FIG. 29 is a diagram showing another layout example of the antenna pattern according to the fourth embodiment of the present invention.

### DETAILED DESCRIPTION OF THE PREFERRED EMBODIMENTS

Now, examples of embodiments of the present invention are described specifically with reference to the drawings. In the drawings that are referred to, the same part is denoted by the same numeral or symbol, so that overlapping description of the same part is omitted as a general rule. Note that in this specification, for simple description, a name of information, a signal, a physical quantity, a state quantity, a member, or the like may be omitted or abbreviated by using a numeral or symbol corresponding to the information, the signal, the physical quantity, the state quantity, the member, or the like. In addition, in any flowchart described later, a plurality of processes in any plurality of steps can be performed in any different order or in parallel as long as no contradiction occurs in the process contents.

### First Embodiment

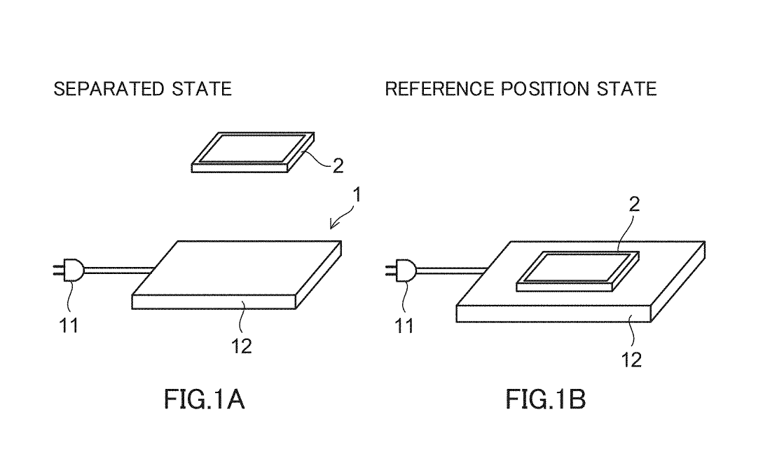

A first embodiment of the present invention is described. FIGS. 1A and 1B are schematic external views of a power feeding device 1 and an electronic device 2 according to the first embodiment. FIG. 1A is an external view of the power feeding device 1 and the electronic device 2 when they are in a separated state, and FIG. 1B is an external view of the power feeding device 1 and the electronic device 2 when they are in a reference position state. Meanings of the separated state and the reference position state are described later in detail. The power feeding device 1 and the electronic device 2 constitute a non-contact power feeding system. The power feeding device 1 is equipped with a power plug 11 for receiving commercial AC power and a power feeding table 12 made of a resin material.

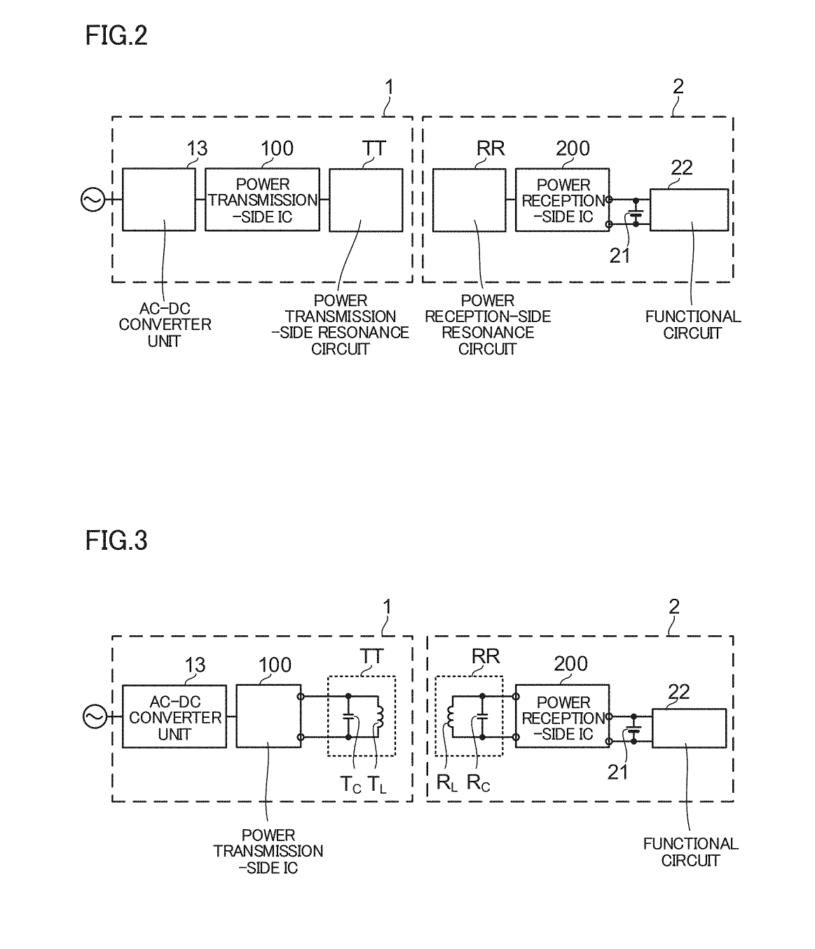

FIG. 2 illustrates a schematic internal structural diagram of the power feeding device 1 and the electronic device 2. The power feeding device 1 includes an AC-DC converter unit 13 that generates a DC voltage having a predetermined voltage value from a commercial AC voltage input via the power plug 11 and outputs the DC voltage, a power transmission-side IC 100 (hereinafter also referred to as an IC 100), which is an integrated circuit that operates using an output voltage of the AC-DC converter unit 13, and a power transmission-side resonance circuit TT (hereinafter also referred to as a resonance circuit TT) connected to the IC 100. The AC-DC converter unit 13, the power transmission-side IC 100, and the resonance circuit TT can be disposed inside the power feeding table 12. The power feeding device 1 may include other circuits besides the IC 100, which operate using the output voltage of the AC-DC converter unit 13.

The electronic device 2 includes a power reception-side IC 200 as an integrated circuit (hereinafter also referred to as an IC 200), a power reception-side resonance circuit RR (hereinafter also referred to as a resonance circuit RR) connected to the IC 200, a battery 21 that is a secondary battery, and a functional circuit 22 that operates based on an output voltage of the battery 21. Although details are described later, the IC 200 can supply charging power to the battery 21. The IC 200 may operate with the output voltage of the battery 21 or with a voltage from a voltage source other than the battery 21. Alternatively, a DC voltage obtained by rectifying a signal for NFC communication (details are described later), which is received from the power feeding device 1, may be a drive voltage for the IC 200. In this case, the IC 200 can operate even if the battery 21 runs out.

The electronic device 2 can be any electronic device such as a mobile phone (including a mobile phone to be classified into a smart phone), a mobile information terminal, a tablet type personal computer, a digital camera, an MP3 player, a pedometer, or a Bluetooth (registered trademark) headset. The functional circuit 22 realizes any function to be realized by the electronic device 2. Therefore, for example, if the electronic device 2 is a smart phone, the functional circuit 22 includes a telephone processing part that realizes telephone communication with a device on the other end, a communication processing part that communicates information with other devices via a communication network, and the like. Alternatively, for example, if the electronic device 2 is a digital camera, the functional circuit 22 includes a driving circuit that drives an imaging sensor, an image processing circuit that generates image data from an output signal of the imaging sensor, and the like. The functional circuit 22 can also be considered as a circuit disposed in an external device of the electronic device 2.

As illustrated in FIG. 3, the resonance circuit TT includes a coil T_{L} as a power transmission-side coil and a capacitor T_{C} as a power transmission-side capacitor, while the resonance circuit RR includes a coil R_{L} as a power reception-side coil and a capacitor R_{C} as a power reception-side capacitor. In the following description, for specific description, unless otherwise noted, the power transmission-side coil T_{L} and the power transmission-side capacitor T_{C} are connected in parallel to each other so that the resonance circuit TT is constituted as a parallel resonance circuit, and the power reception-side coil R_{L} and the power reception-side capacitor R_{C} are connected in parallel to each other so that the resonance circuit RR is constituted as a parallel resonance circuit. However, the power transmission-side coil T_{L} and the power transmission-side capacitor T_{C} may be connected in series with each other so that the resonance circuit TT is constituted as a series resonance circuit, and the power reception-side coil R_{L} and the power reception-side capacitor R_{C} may be connected in series with each other so that the resonance circuit RR is constituted as a series resonance circuit.

As illustrated in FIG. 1B, when the electronic device 2 is placed on the power feeding table 12 within a predetermined range, communication, power transmission, and power reception can be performed between the devices 1 and 2 by magnetic resonance method (i.e. utilizing magnetic resonance). The magnetic resonance is also called magnetic field resonance.

The communication between the devices 1 and 2 is wireless communication using near field communication (NFC) (hereinafter referred to as NFC communication), and its communication carrier frequency is 13.56 MHz (megahertz). In the following description, 13.56 MHz is referred to as a reference frequency. The NFC communication between the devices 1 and 2 is performed by magnetic resonance method using the resonance circuits TT and RR, and hence resonance frequencies of the resonance circuits TT and RR are both set to the reference frequency. However, as described later, the resonance frequency of the resonance circuit RR can be temporarily changed from the reference frequency.

The power transmission and power reception between the devices 1 and 2 are NFC power transmission from the power feeding device 1 to the electronic device 2 and NFC power reception by the electronic device 2. A set of the power transmission and power reception is referred to as NFC power transfer or simply as power transfer. The transmission of electric power from the coil T_{L} to the coil R_{L} by magnetic resonance method can realize the power transfer in a non-contact manner.

In the power transfer utilizing magnetic resonance, alternating current is supplied to the power transmission-side coil T_{L}, and hence alternating magnetic field having the reference frequency is generated by the power transmission-side coil T_{L}. Then, the alternating magnetic field propagates to the resonance circuit RR resonating at the reference frequency, and hence alternating current flows in the power reception-side coil R_{L}. In other words, electric power is transmitted from the resonance circuit TT including the power transmission-side coil T_{L} to the resonance circuit RR including the power reception-side coil R_{L}. Note that the magnetic field generated by the coil T_{L} or the coil R_{L} in the NFC communication or power transfer is an alternating magnetic field oscillating at the reference frequency, unless otherwise noted, although may not be described in the following description.

The state in which the electronic device 2 is placed on the power feeding table 12 within a predetermined range so that the above-mentioned NFC communication and power transfer can be performed is referred to as a reference position state (see FIG. 1B). When magnetic resonance is utilized, communication and power transfer can be performed even if a distance between the devices is relatively large. However, if the electronic device 2 is substantially far from the power feeding table 12, the NFC communication and power transfer cannot be performed. The state in which the electronic device 2 is sufficiently far from the power feeding table 12 so that the NFC communication and power transfer cannot be performed is referred to as a separated state (see FIG. 1A). Note that the power feeding table 12 illustrated in FIG. 1A has a flat surface, but a recess or the like corresponding to a shape of the electronic device 2 to be placed may be formed in the power feeding table 12.

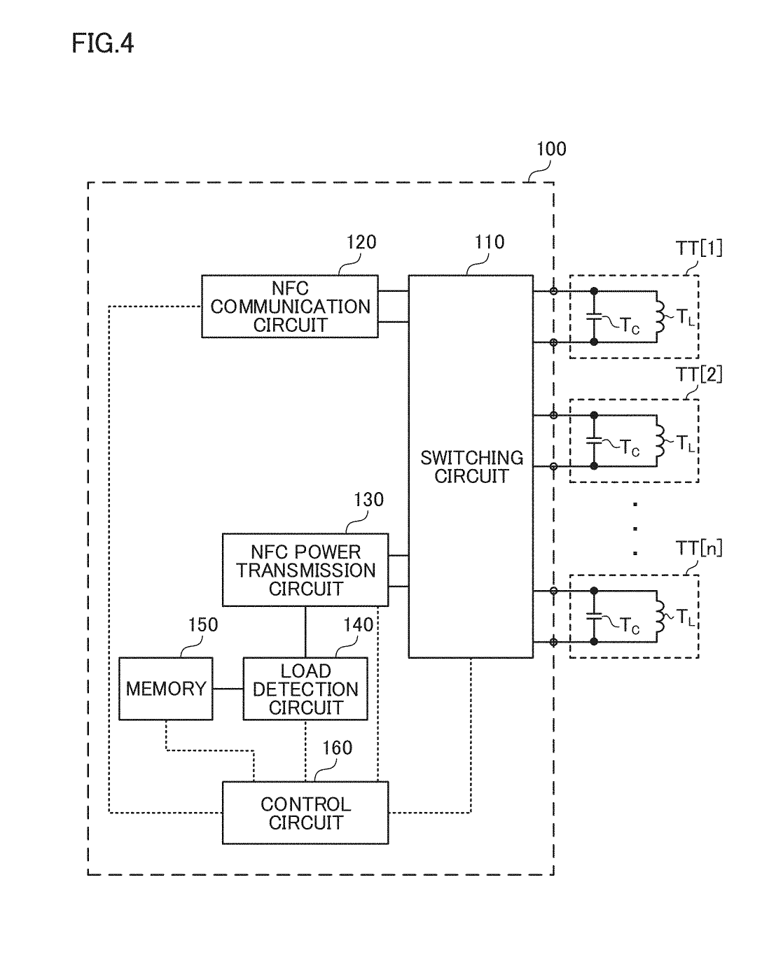

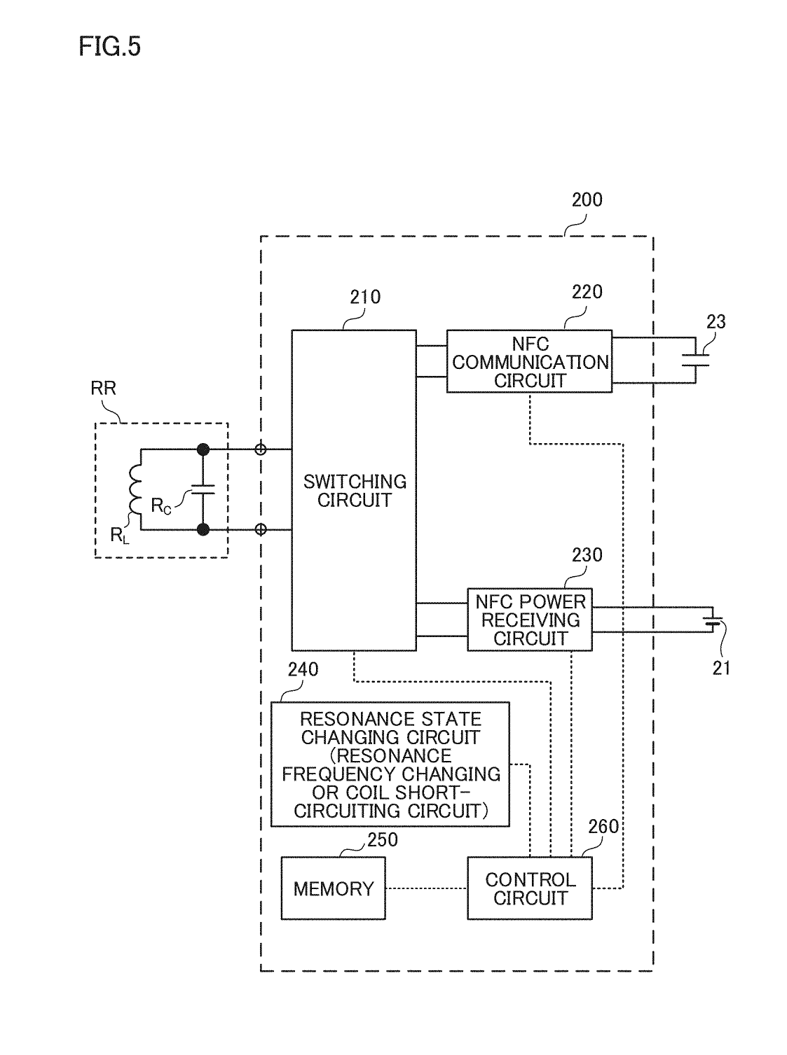

FIG. 4 is a partial structural diagram of the power feeding device 1, which includes an internal block diagram of the IC 100. The IC 100 includes individual parts denoted by numerals 110, 120, 130, 140, 150, and 160. Although not illustrated in FIGS. 2 and 3, the power feeding device 1 is equipped with n resonance circuits TT, which are connected to the IC 100. If it is necessary to discriminate the n resonance circuits TT from each other, the n resonance circuits TT are denoted by TT[1] to TT[n]. Symbol n is an arbitrary integer of 2 or more. Resonance frequencies of the resonance circuits TT[1] to TT[n] are all set to the reference frequency. Note that, in the following description, when simply referred to as the coil T_{L}, it may be interpreted as the coil T_{L} in the resonance circuit TT[1] or as the coil T_{L} in any one of the resonance circuits TT[1] to TT[n]. The same is true for the capacitor T_{C}.

FIG. 5 is a partial structural diagram of the electronic device 2, which includes an internal block diagram of the IC 200. The IC 200 includes individual parts denoted by numerals 210, 220, 230, 240, 250, and 260. In addition, a capacitor 23, which outputs a drive voltage for IC 200, may be connected to the IC 200. The capacitor 23 can output a DC voltage obtained by rectifying a signal for NFC communication, which is received from the power feeding device 1.

A switching circuit 110 can connect any one of the resonance circuits TT[1] to TT[n] to either an NFC communication circuit 120 or an NFC power transmission circuit 130, under control by a control circuit 160. A plurality of switches disposed between the resonance circuits TT[1] to TT[n] and the communication circuit 120 as well as the power transmission circuit 130 can constitute the switching circuit 110. Any switch described in this specification may be constituted of a semiconductor switching element such as a field-effect transistor.

A switching circuit 210 connects the resonance circuit RR to either an NFC communication circuit 220 or an NFC power receiving circuit 230 under control by a control circuit 260. A plurality of switches disposed between the resonance circuit RR and the communication circuit 220 as well as the power reception circuit 230 can constitute the switching circuit 210.

The state in which any one of the resonance circuits TT[1] to TT[n] is connected to the NFC communication circuit 120 via the switching circuit 110, and the resonance circuit RR is connected to the NFC communication circuit 220 via the switching circuit 210 is referred to as a communication connection state. The NFC communication can be performed in the communication connection state. In the communication connection state, the resonance circuit connected to the NFC communication circuit 120 may be any one of the resonance circuits TT[1] to TT[n] (i.e. any one of the resonance circuits TT[1] to TT[n] may be used to perform the NFC communication), but in this example, it is supposed that the resonance circuit TT[1] is mainly connected to the NFC communication circuit 120. In this case, the NFC communication circuit 120 can supply an alternating-current signal (alternating current) of the reference frequency to the resonance circuit TT[1] in the communication connection state. The NFC communication between the devices 1 and 2 is performed in a half-duplex method.

In the communication connection state, when the power feeding device 1 is a transmitting side, the NFC communication circuit 120 superimposes an arbitrary information signal on the alternating-current signal to be supplied to the resonance circuit TT[1], and thus the information signal is transmitted from the coil T_{L} in the resonance circuit TT[1] as a power feeding device-side antenna coil and is received by the coil R_{L} in the resonance circuit RR as an electronic device-side antenna coil. The information signal received by the coil R_{L} is extracted by NFC communication circuit 220. In the communication connection state, when the electronic device 2 is a transmitting side, the NFC communication circuit 220 can transmit an arbitrary information signal (response signal) from the coil R_{L} in the resonance circuit RR to the coil T_{L} in the resonance circuit TT[1]. This transmission is performed in a load modulation method, which changes an impedance of the coil R_{L} in the resonance circuit RR (electronic device-side antenna coil) viewed from the coil T_{L} in the resonance circuit TT[1] (power feeding device-side antenna coil) based on the ISO standard (such as ISO14443 standard), as known well. The information signal transmitted from the electronic device 2 is extracted by the NFC communication circuit 120.

The state in which any one of the resonance circuits TT[1] to TT[n] is connected to the NFC power transmission circuit 130 via the switching circuit 110, and the resonance circuit RR is connected to the NFC power receiving circuit 230 via the switching circuit 210 is referred to as a power feeding connection state.

In the power feeding connection state, the NFC power transmission circuit 130 can perform the power transmission operation, and the NFC power receiving circuit 230 can perform the power reception operation. The power transmission operation and the power reception operation realize the power transfer. Prior to the power transmission operation, the control circuit 160 selects one of the resonance circuits TT[1] to TT[n] as a target resonance circuit. In the power transmission operation, the power transmission circuit 130 supplies a power transmission alternating-current signal (power transmission alternating current) of the reference frequency to the target resonance circuit, so that a power transmission magnetic field (power transmission alternating magnetic field) of the reference frequency is generated by the power transmission-side coil T_{L} in the target resonance circuit, and thus electric power is transmitted from the target resonance circuit (power transmission-side coil T_{L} in the target resonance circuit) to the resonance circuit RR by magnetic resonance method. Note that supplying the alternating-current signal to the resonance circuit including the power transmission-side coil T_{L} has the same meaning as supplying the alternating-current signal to the power transmission-side coil T_{L}. The electric power received by the power reception-side coil R_{L} based on the power transmission operation is sent to the power reception circuit 230, and in the power reception operation, the power reception circuit 230 generates any DC power from the received electric power and outputs the DC power. The output power of the power reception circuit 230 can charge the battery 21.

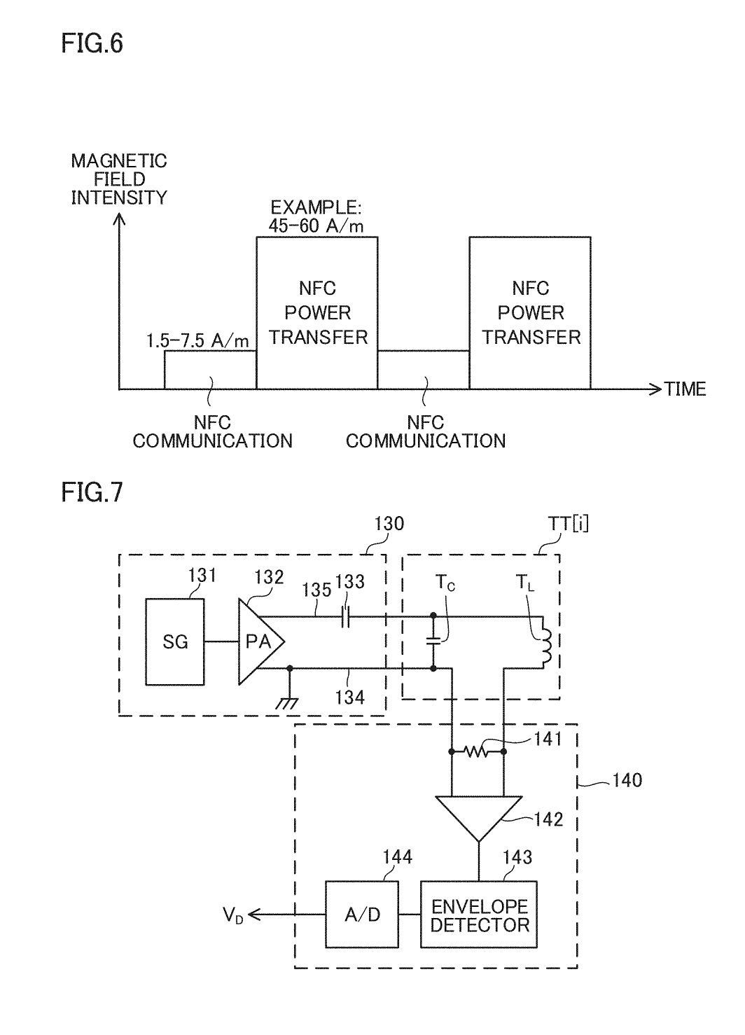

Also when the NFC communication is performed in the communication connection state, the coil T_{L} or R_{L} generates a magnetic field, and magnetic field intensity in the NFC communication is within a predetermined range. A lower limit and an upper limit of the range are defined by the NFC standard, and they are 1.5 A/m and 7.5 A/m, respectively. In contrast, in the power transfer (i.e. power transmission operation), intensity of the magnetic field generated by the power transmission-side coil T_{L} in the target resonance circuit (magnetic field intensity of the power transmission magnetic field) is larger than the upper limit described above and is approximately 45 to 60 A/m, for example. In the non-contact power feeding system including the devices 1 and 2, the NFC communication and the power transfer (NFC power transfer) can be performed alternately, and a manner of the magnetic field intensity in this case is illustrated in FIG. 6.

A load detection circuit 140 detects magnitude of load on the power transmission-side coil T_{L} in a resonance circuit TT[i] connected to the power transmission circuit 130, i.e. magnitude of load on the power transmission-side coil T_{L} when the alternating-current signal (alternating current) is supplied from the power transmission circuit 130 to the power transmission-side coil T_{L}. In this case, i is an arbitrary integer smaller than or equal to n. FIG. 7 illustrates a relationship among the power transmission circuit 130, the load detection circuit 140, and the resonance circuit TT[i] when the power transmission circuit 130 is connected to the resonance circuit TT[i] in the power feeding connection state. Note that the switching circuit 110 is not illustrated in FIG. 7.

The power transmission circuit 130 includes a signal generator 131 that generates a sine wave signal of the reference frequency, an amplifier (power amplifier) 132 that amplifies the sine wave signal generated by the signal generator 131 and outputs the amplified sine wave signal between lines 134 and 135 with reference of a potential of the line 134, and a capacitor 133. On the other hand, the load detection circuit 140 includes a sense resistor 141, an amplifier 142, an envelope detector 143, and an A-D converter 144. Signal intensity of the sine wave signal generated by the signal generator 131 is fixed to a constant value, but an amplification factor of the amplifier 132 is set in a variable manner by the control circuit 160.

One terminal of the capacitor 133 is connected to the line 135. In the power feeding connection state, the other terminal of the capacitor 133 is commonly connected to one terminals of the capacitor T_{C} and the coil T_{L} in the resonance circuit TT[i], and the other terminal of the coil T_{L} in the resonance circuit TT[i] is commonly connected to the line 134 and the other terminal of the capacitor T_{C} in the resonance circuit TT[i] via the sense resistor 141.

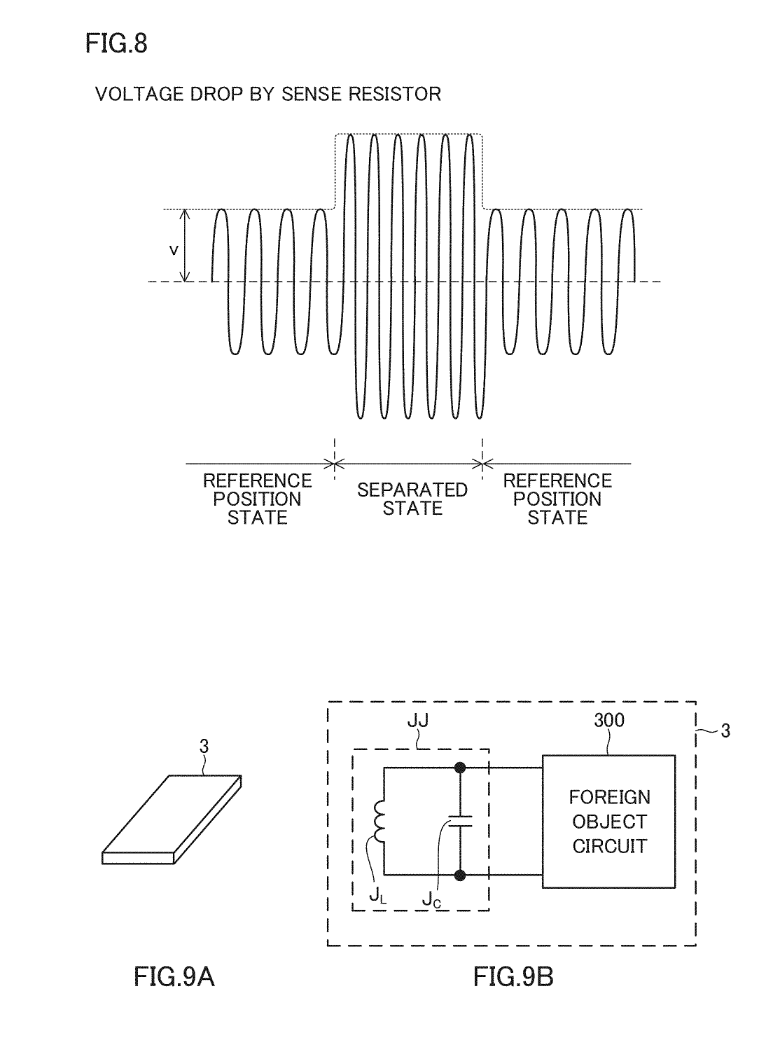

When the resonance circuit TT[i] is the target resonance circuit, the power transmission operation is realized by supplying the alternating-current signal from the amplifier 132 to the resonance circuit TT[i] via the capacitor 133. In the power feeding connection state, when the alternating-current signal is supplied from the amplifier 132 to the resonance circuit TT[i], alternating current of the reference frequency flows in the power transmission-side coil T_{L} in the resonance circuit TT[i], and as a result, an AC voltage drop is generated by the sense resistor 141. A solid line waveform in FIG. 8 is a voltage waveform of the voltage drop by the sense resistor 141. As to the resonance circuit TT[i], under the condition of a constant intensity of the magnetic field generated by the power transmission-side coil T_{L}, when the electronic device 2 is made close to the power feeding table 12, current based on the magnetic field generated by the power transmission-side coil T_{L} flows in the power reception-side coil R_{L}, and a counter electromotive force based on current that has flown in the power reception-side coil R_{L} is generated in the power transmission-side coil T_{L}. The counter electromotive force acts so as to reduce current flowing in the power transmission-side coil T_{L}. Therefore, as illustrated in FIG. 8, amplitude of the voltage drop by the sense resistor 141 in the reference position state is smaller than that in the separated state.

The amplifier 142 amplifies a signal of the voltage drop by the sense resistor 141. The envelope detector 143 detects an envelope of the signal amplified by the amplifier 142, so as to output an analog voltage signal proportional to the voltage v in FIG. 8. The A-D converter 144 converts an output voltage signal of the envelope detector 143 into a digital signal so as to output a digital voltage value V_{D}. As understood from the above description, the voltage value V_{D} has a value proportional to an amplitude of current flowing in the sense resistor 141 (therefore, amplitude of current flowing in the power transmission-side coil T_{L} in the resonance circuit TT[i]). Thus, the load detection circuit 140 detects amplitude of current flowing in the power transmission-side coil T_{L} in the resonance circuit TT[i], and the amplitude detection value can be considered to be the voltage value V_{D}.

For the power transmission-side coil T_{L} generating a magnetic field, a coil such as the power reception-side coil R_{L}, which forms a magnetic coupling with the power transmission-side coil T_{L}, can be considered as a load. The voltage value V_{D} as a detection value by the load detection circuit 140 varies depending on the magnitude of the load. Therefore, the load detection circuit 140 can be considered to detect magnitude of load based on an output of the voltage value V_{D}. The magnitude of load can be said to be a magnitude of load on the power transmission-side coil T_{L} in the power transmission, or can be said to be a magnitude of load on the electronic device 2 in the power transmission viewed from the power feeding device 1. Note that the sense resistor 141 may be disposed inside the IC 100 or outside the IC 100.

A memory 150 (see FIG. 4) is constituted of a random access memory (RAM) and a read only memory (ROM), so as to store arbitrary information. A ROM in the memory 150 includes a nonvolatile memory classified into a flash memory or an electrically erasable programmable read-only memory (EEPROM), for example. The control circuit 160 integrally controls operations of individual portions inside the IC 100. The control circuit 160 performs controls, including switching operation control of the switching circuit 110, content control and execution/non-execution control of communication operation and power transmission operation by the communication circuit 120 and the power transmission circuit 130, control of operation by the load detection circuit 140, and write control and read control of the memory 150, for example. In addition, the control circuit 160 includes a timer (not shown) and can measure time period between arbitrary time points.

A resonance state changing circuit 240 (see FIG. 5) in the electronic device 2 is a resonance frequency changing circuit that realizes a resonance frequency changing operation for changing the resonance frequency of the resonance circuit RR from the reference frequency to a predetermined frequency f_{M} that is sufficiently larger or smaller than the reference frequency, or is a coil short-circuiting circuit that realizes coil short-circuiting operation for short-circuiting the power reception-side coil R_{L} in the resonance circuit RR. The resonance frequency changing operation and the coil short-circuiting operation can be realized by an arbitrary method such as the method described in Patent Document 1 (JP-A-2017-11954). For example, a series circuit of a switch and a capacitor is connected in parallel with the power reception-side capacitor R_{C}, and the resonance frequency of the resonance circuit RR can be changed from the reference frequency to the predetermined frequency f_{M} by turning on the switch. The power reception-side coil R_{L} can be short-circuited by turning on the switch connected in parallel with the power reception-side coil R_{L}. In the following description, for simple description, the resonance frequency changing operation or the coil short-circuiting operation may be referred to as an f_{O} changing or short-circuiting operation.

A memory 250 is constituted of a random access memory (RAM) and a read only memory (ROM) so as to store any information. The ROM of the memory 250 includes a nonvolatile memory such as a flash memory or an electrically erasable programmable read-only memory (EEPROM). The control circuit 260 integrally controls operations of individual portions in the IC 200. The control circuit 260 performs controls, including, for example, switching operation control of the switching circuit 210, content control and execution/non-execution control of communication operation and power reception operation by the communication circuit 220 and the power reception circuit 230, operation control of the changing circuit 240, and write control and read control of the memory 250. In addition, the control circuit 260 includes a timer (not shown) and can measure time period between arbitrary time points.

The control circuit 160 of the power feeding device 1 determines whether or not a foreign object is present on the power feeding table 12 and can control the power transmission circuit 130 to perform the power transmission operation only when no foreign object is present. The foreign object in this embodiment includes an object that can generate current (current in the foreign object) based on the magnetic field generated by the power transmission-side coil T_{L}, which is the power transmission-side coil T_{L} included in any one of the resonance circuits TT[1] to TT[n], supplied with the alternating-current signal of the reference frequency, when approaching to the power feeding device 1, unlike the electronic device 2 or a component of the electronic device 2 (such as the power reception-side coil R_{L}). In this embodiment, presence of a foreign object can be understood to mean that the foreign object is present at a position that causes non-negligible current to flow in the foreign object due to the magnetic field generated by the power transmission-side coil T_{L}. Note that current flowing in the foreign object due to the magnetic field generated by the power transmission-side coil T_{L} causes electromotive force (or counter electromotive force) in a coil (T_{L} or R_{L}) facing the foreign object to couple therewith, and hence can give a non-negligible influence to characteristics of the circuit including the coil.

FIG. 9A illustrates a schematic external view of a foreign object 3 as one type of the foreign object, and FIG. 9B illustrates a schematic internal structural diagram of the foreign object 3. The foreign object 3 includes a resonance circuit JJ constituted of a parallel circuit of a coil J_{L} and a capacitor J_{C}, and a foreign object circuit 300 connected to the resonance circuit JJ. A resonance frequency of the resonance circuit JJ is set to the reference frequency. Unlike the electronic device 2, the foreign object 3 is a device that is not compatible with the power feeding device 1. For example, the foreign object 3 is an object (such as a non-contact IC card) including a wireless IC tag having an antenna coil (coil J_{L}) of 13.56 MHz that does not respond to the NFC communication. In addition, for example, the foreign object 3 is a non-contact IC card or the like, which has the NFC communication function but is not in a state capable of communication, because a positional relationship between the coil J_{L} and the power transmission-side coil T_{L} is not set to a communicable relationship (for example, the axis of the coil J_{L} is largely inclined from the axis of the power transmission-side coil T_{L}). In addition, for example, the foreign object 3 is an electronic device having the NFC communication function, which is disabled though. For example, a smart phone having the NFC communication function, which is turned off by software though, can be the foreign object 3. In addition, a smart phone whose NFC communication function is enabled, which does not have the power reception function, is also classified into the foreign object 3.

In a state where the foreign object 3 described above is placed on the power feeding table 12, if the power feeding device 1 performs the power transmission operation, a strong magnetic field generated by the power transmission-side coil T_{L} (e.g. a magnetic field having magnetic field intensity of 12 A/m or larger) may cause a breakdown of the foreign object 3. For example, the strong magnetic field in the power transmission operation could increase a terminal voltage of the coil J_{L} in the foreign object 3 on the power feeding table 12 up to 100-200 V, and the foreign object 3 is broken down if it does not have such high withstand voltage.

It is possible to determine whether or not the foreign object 3 is present based on current amplitude of the power transmission-side coil T_{L}, utilizing characteristics that the current amplitude is decreased along with an increase in load on the power transmission-side coil T_{L} when the foreign object 3 is present. However, the antenna coil (coil J_{L}) of the foreign object 3 can have various shapes, and the current amplitude changes variously when the foreign object 3 is present, depending on the shape of the antenna coil. The power feeding device 1 is provided with a plurality of power transmission-side coils T_{L} for correctly detecting whether or not a foreign object is present.

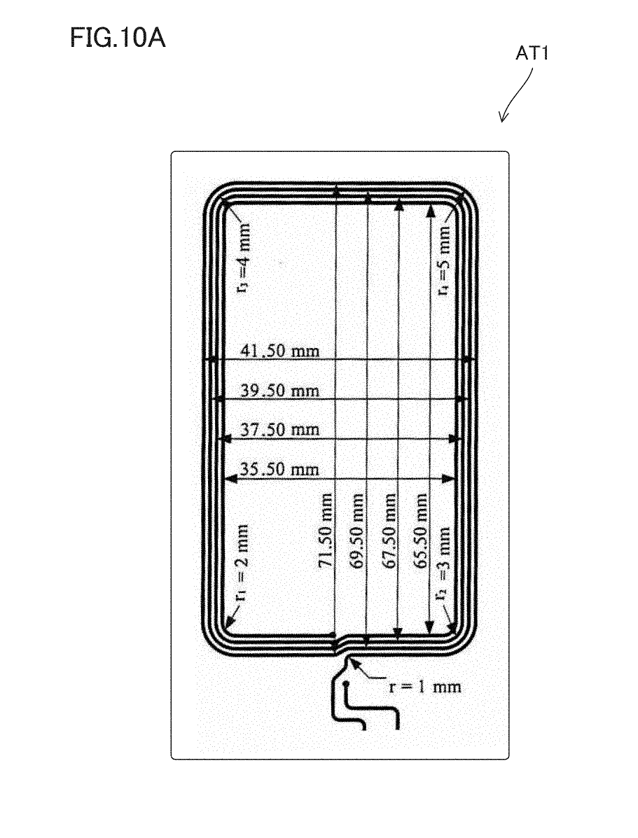

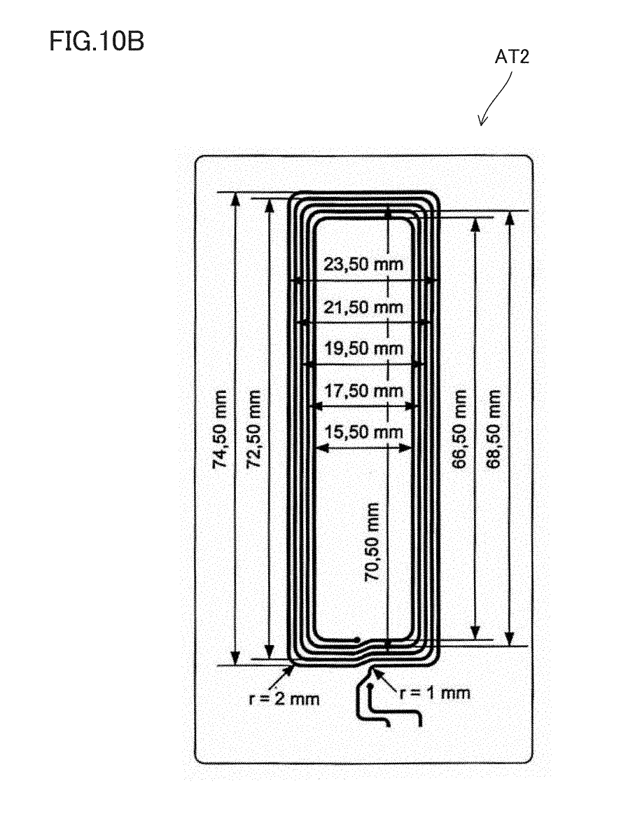

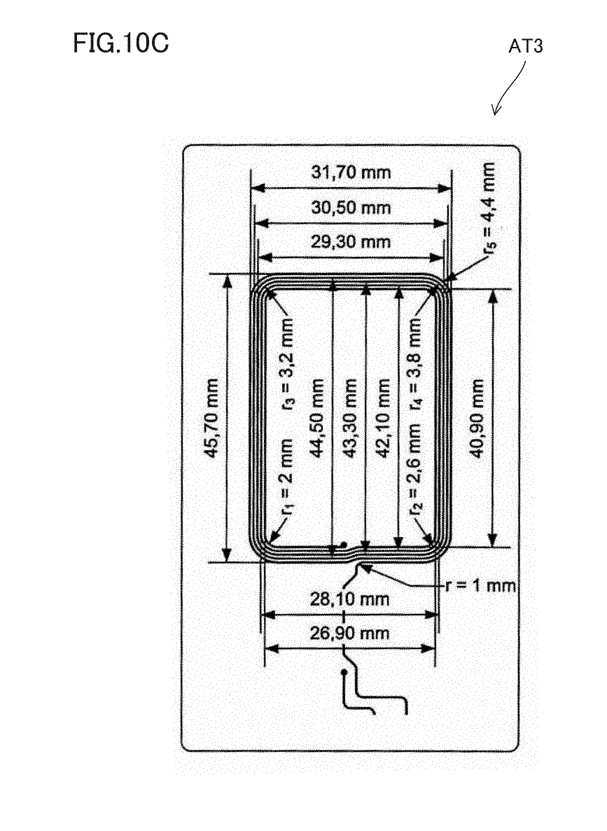

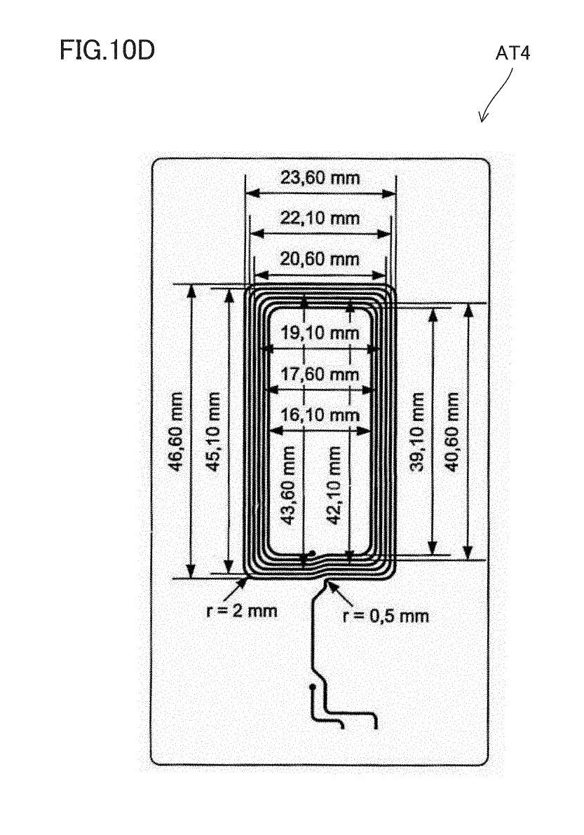

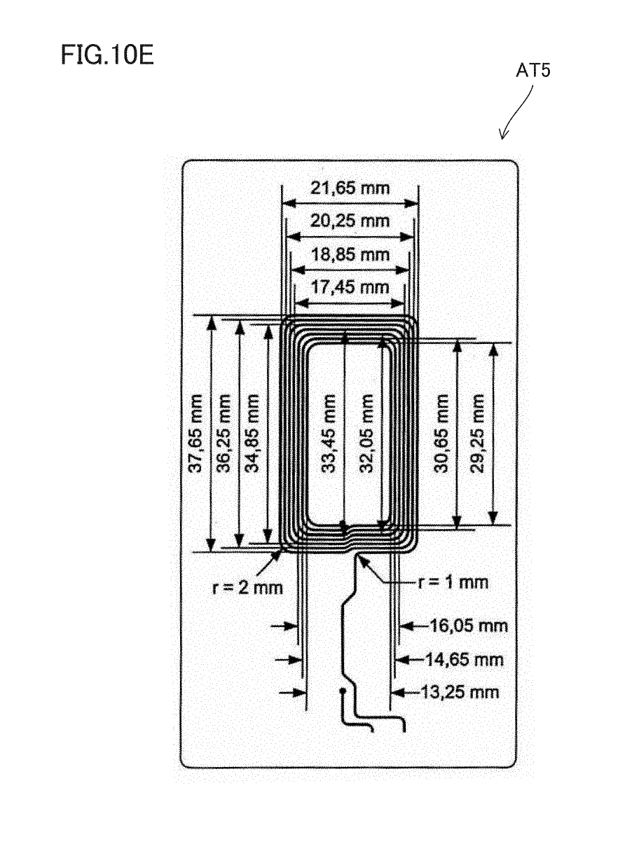

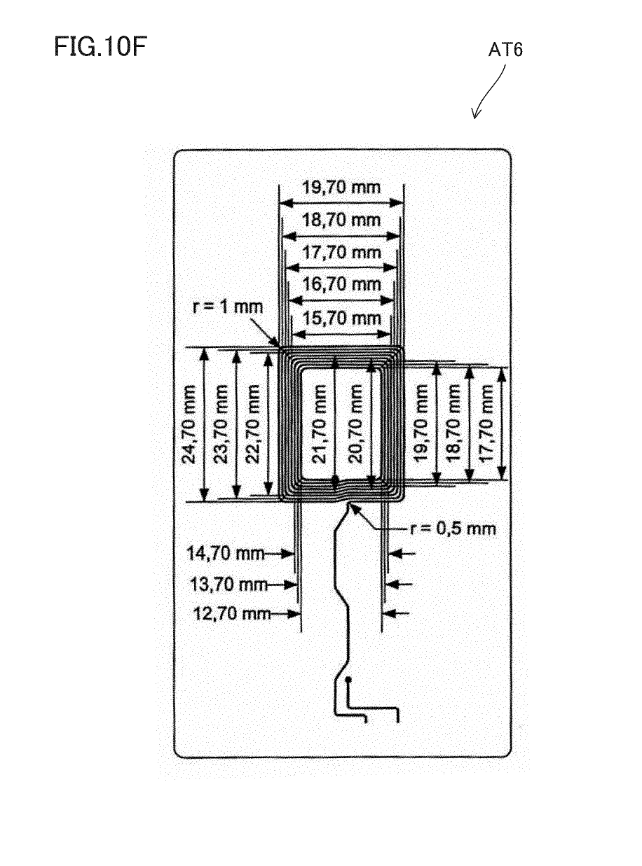

With reference to FIGS. 10A to 10F, further description is added. Each of AT1 to AT6 indicates a reference antenna coil defined in ISO14443 standard as an antenna coil to be mounted in a non-contact IC card. A non-contact IC card including any one of the antenna coils AT1 to AT6 as the coil J_{L} of FIG. 9 can be the foreign object 3. The antenna coils AT1 to AT6 have different shapes, and basically a size of the antenna coil becomes smaller from AT1 to AT6. In this specification, a shape of coil is a concept including a size of the coil. Therefore, even if a first coil and a second coil have similarity relationship, if they have different sizes, the first coil and the second coil have different shapes from each other. As to an arbitrary coil, a size of the coil can be considered to be an area occupied by the perimeter of the coil in the direction perpendicular to the center axis of the coil. When the coil forms a loop antenna, an area of a part enclosed by wiring of the coil on a loop surface of the loop antenna (i.e. a surface on which the wiring of the coil is disposed) corresponds to a size of the coil.

When a shape of the power transmission-side coil T_{L} used for foreign object detection is identical or similar to a shape of the coil J_{L} of the foreign object 3, sensitivity of detection whether or not the foreign object 3 is present using the current amplitude of the power transmission-side coil T_{L} is sufficiently high. On the other hand, as described above, there are various shapes of the antenna coil (coil J_{L}) in the foreign object 3. Considering this, in this embodiment, the resonance circuits TT[1] to TT[n] are used for performing the foreign object detection process. The total n power transmission-side coils T_{L} in the resonance circuits TT[1] to TT[n] are antenna coils having different shapes (including sizes as described above) from each other. For example, if n is 6, the power transmission-side coils T_{L} in the resonance circuits TT[1] to TT[6] may have shapes that are the same as shapes of the antenna coils AT1 to AT6, respectively.

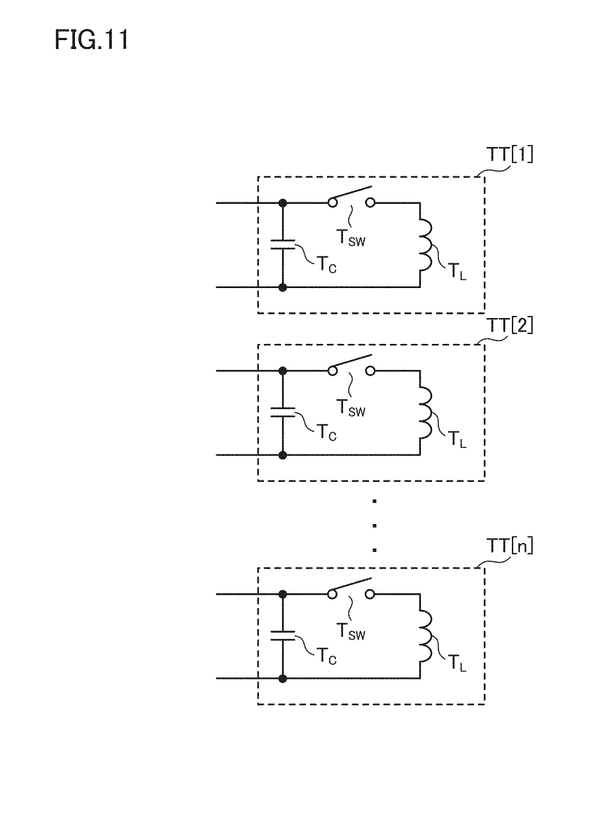

However, when performing the foreign object detection process using the resonance circuit TT[i], it is necessary to prevent the power transmission-side coils T_{L} of resonance circuits other than the resonance circuit TT[i] from behaving like the coil T_{J} of the foreign object 3 (i is an integer). Therefore, although not noted in the above description, in reality, a switch T_{SW} is disposed in each of the resonance circuits TT[1] to TT[n] as illustrated in FIG. 11. Under control by the control circuit 160, the switches T_{SW} in the resonance circuits TT[1] to TT[n] are individually turned on or off. In the resonance circuit TT[i], the coil T_{L} and the capacitor T_{C} are connected so as to form the resonance circuit when the switch T_{SW} is turned on, while the coil T_{L} and the capacitor T_{C} are disconnected so that the resonance circuit is not formed when the switch T_{SW} is turned off. As the parallel resonance circuit is supposed in this example, the switch T_{SW} is inserted in series in the wire connecting one terminal of the coil T_{L} and one terminal of the capacitor T_{C} in the resonance circuit TT[i], so that the current loop via the coil T_{L} is not formed when the switch T_{SW} is turned off.

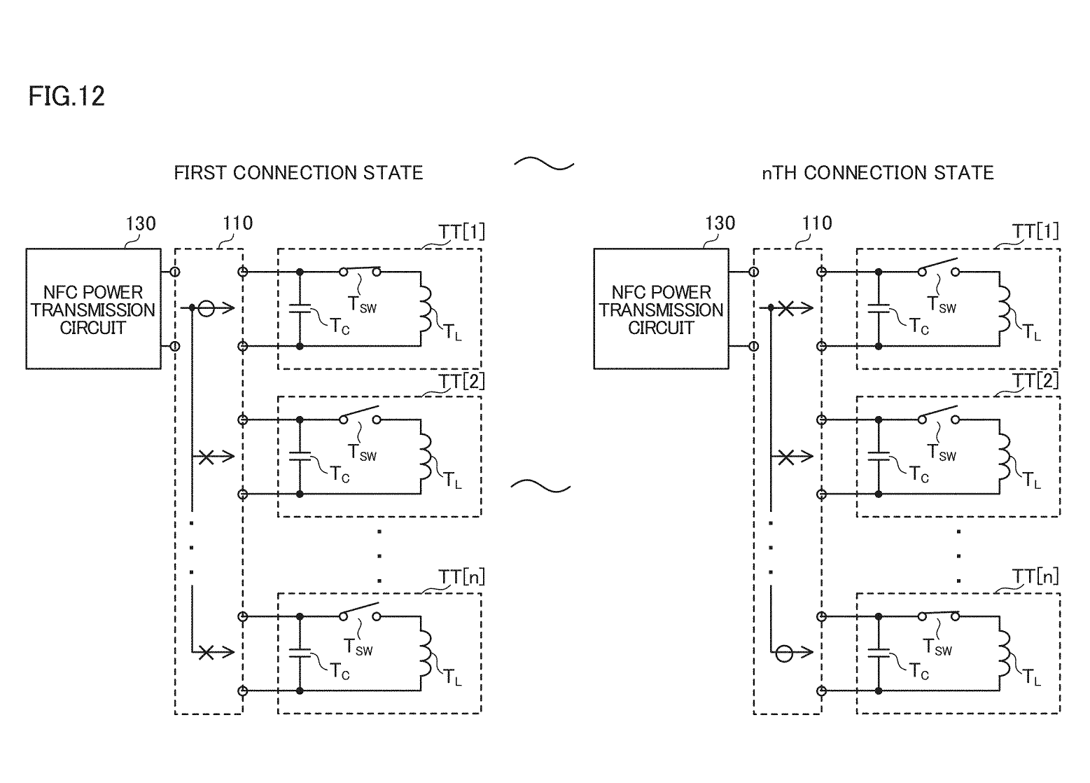

Further, the control circuit 160 can control the switching circuit 110 and the switches T_{SW} of the resonance circuits TT[1] to TT[n] so as to realize any one of first to nth connection states as illustrated in FIG. 12. In the ith connection state, the NFC power transmission circuit 130 is connected only to the resonance circuit TT[i] among the resonance circuits TT[1] to TT[n], the switch T_{SW} of the resonance circuit TT[i] is turned on, and switches T_{SW} of resonance circuits other than the resonance circuit TT[i] among the resonance circuits TT[1] to TT[n] are turned off. In the power feeding device 1, in the communication connection state in which the NFC communication is performed using the resonance circuit TT[1], the NFC communication circuit 120 is connected to the resonance circuit TT[1] via the switching circuit 110, and the switch T_{SW} of the resonance circuit TT[1] is turned on, while the switches T_{SW} of the resonance circuit TT[2] to TT[n] are turned off.

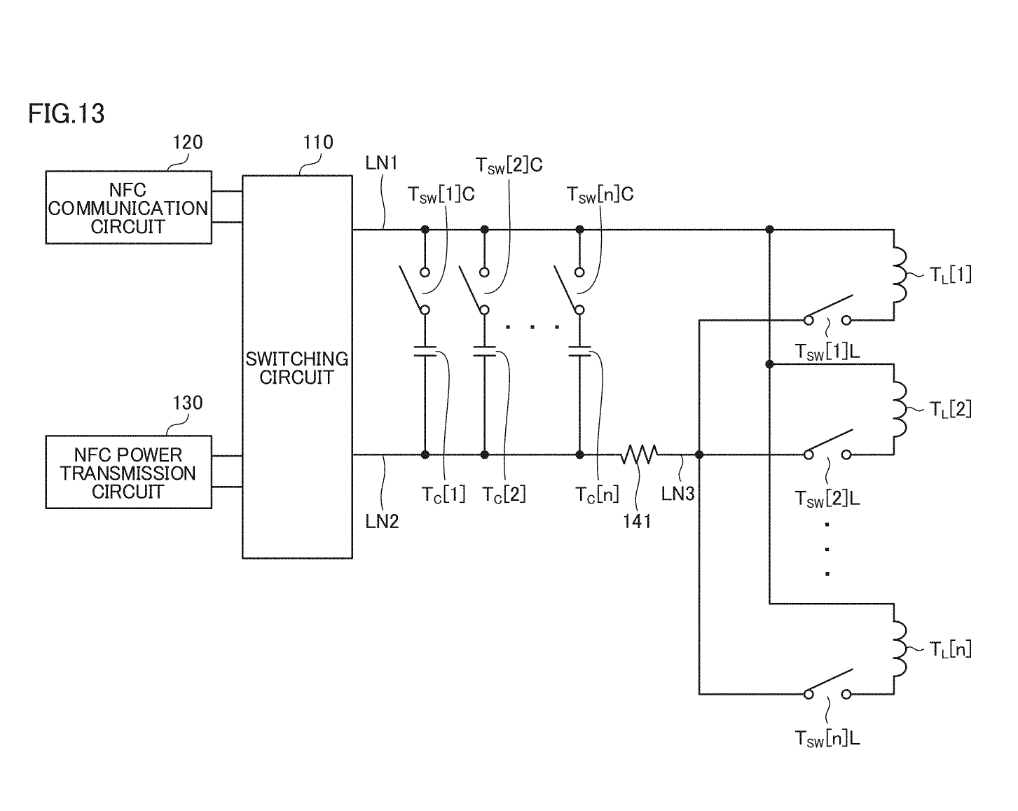

FIG. 13 illustrates a circuit example in the power feeding device 1 for realizing the first to nth connection states. In FIG. 13, the power transmission-side coil T_{L} and the power transmission-side capacitor T_{C} in the resonance circuit TT[i] are denoted by symbols T_{L}[i] and T_{C}[i], respectively, and switches T_{SW}[i]L and T_{SW}[i]C are disposed as the switch T_{SW} of the resonance circuit TT[i]. The NFC communication circuit 120 or the NFC power transmission circuit 130 is connected to lines LN1 and LN2 as wirings via the switching circuit 110. The line LN1 is connected to one terminals of capacitors T_{C}[1] to T_{C}[n] via switches T_{SW}[1]C to T_{SW}[n]C, respectively, and the other terminals of the capacitors T_{C}[1] to T_{C}[n] are connected to the line LN2. In addition, the line LN1 is commonly connected to one terminals of coils T_{L}[1] to T_{L}[n], and the other terminals of the coils T_{L}[1] to T_{L}[n] are connected to a line LN3 via switches T_{SW}[1]L to T_{SW}[n]L, respectively. The line LN3 is connected to the line LN2 via the sense resistor 141.

In the circuit example of FIG. 13, in the ith connection state, the power transmission circuit 130 is connected to the lines LN1 and LN2, an only the switches T_{SW}[i]L and T_{SW}[i]C are turned on among the switches T_{SW}[1]L to T_{SW}[n]L and T_{SW}[1]C to T_{SW}[n]C, while the other switches are all turned off. In the communication connection state using the power transmission-side coil T_{L}[i], the communication circuit 120 is connected to the lines LN1 and LN2, and only the switches T_{SW}[i]L, and T_{SW}[i]C, are turned on among the switches T_{SW}[1]L to T_{SW}[n]L and T_{SW}[1]C to T_{SW}[n]C, while the other switches are all turned off. However, in the power feeding connection state, the power transmission circuit 130 is connected to the lines LN1 and LN2, while the communication circuit 120 is connected to the lines LN1 and LN2 in the communication connection state.

[Foreign Object Detection Process (Foreign Object Detection Process Before Power Transfer)]

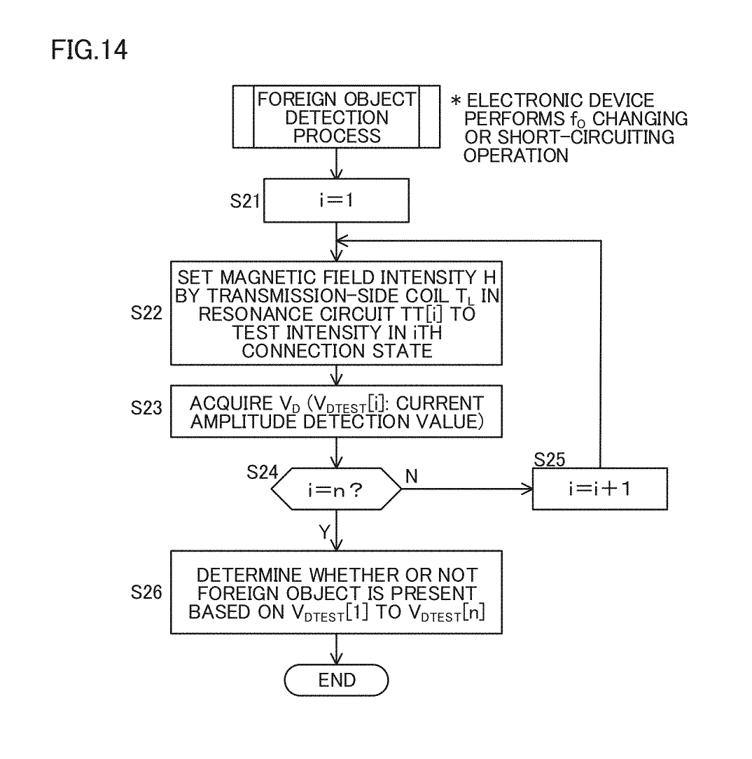

With reference to FIG. 14, the foreign object detection process for detecting whether or not the foreign object 3 is present on the power feeding table 12 is described. FIG. 14 is a flowchart of the foreign object detection process performed by the power feeding device 1 before the power transfer. First, 1 is substituted into a variable i in Step S21. After that, in Step S22, the control circuit 160 controls the switching circuit 110 and the switches T_{SW} so as to realize the ith connection state, and sets magnetic field intensity H by the power transmission-side coil T_{L} of the resonance circuit TT[i] to a predetermined test intensity. In the next Step S23, the control circuit 160 uses the load detection circuit 140 so as to acquire the voltage value V_{D} when the test magnetic field is generated, as a voltage value V_{DTEST}[i].

As to the resonance circuit TT[i], the magnetic field intensity H is intensity of the magnetic field generated by the power transmission-side coil T_{L} in the resonance circuit TT[i], and more specifically, it is magnetic field intensity of the alternating magnetic field oscillating at the reference frequency generated by the power transmission-side coil T_{L} in the resonance circuit TT[i]. As to the resonance circuit TT[i], to set the magnetic field intensity H to the test intensity means to control the power transmission circuit 130 so that a predetermined test alternating-current signal (test alternating current) is supplied to the resonance circuit TT[i], and hence to control the power transmission-side coil T_{L} in the resonance circuit TT[i] to generate the alternating magnetic field that has the test intensity and oscillates at the reference frequency. The control circuit 160 controls the amplification factor of the amplifier 132 (see FIG. 7) so that the magnetic field intensity H can be variably set.

Therefore the voltage value V_{DTEST}[i] to be called a current amplitude detection value has a value corresponding to an amplitude of current flowing in the power transmission-side coil T_{L} in the resonance circuit TT[i], when the test magnetic field that has the test intensity and oscillates at the reference frequency is generated by the power transmission-side coil T_{L} in the resonance circuit TT[i] in the ith connection state. Note that, during the period in which the foreign object detection process is performed, the electronic device 2 is performing the f_{O} changing or short-circuiting operation (resonance frequency changing operation or coil short-circuiting operation) according to an instruction from the power feeding device 1 via the NFC communication.

The magnetic field intensity of the test magnetic field (i.e. test intensity) is set to be smaller than the magnetic field generated by the power transmission-side coil T_{L} intensity in the power transfer (i.e. in the power transmission operation) (i.e. magnetic field intensity of the power transmission magnetic field, which is 45 to 60 A/m, for example), and is within a range from the lower limit of 1.5 A/m to the upper limit of 7.5 A/m of the magnetic field intensity for communication. Therefore, there is little or no possibility that the foreign object 3 is broken by the test magnetic field.

In Step S24 after Step S23, the control circuit 160 determines whether or not “i=n” holds. If “i=n” holds, the process proceeds to Step S26, and otherwise 1 is added to the variable i in Step S25 and the process returns to Step S22 so that the process of Step S22 and Step S23 is repeated. Therefore when reaching Step S26, the voltage values V_{DTEST}[1] to V_{DTEST}[n] are acquired. Note that the load detection circuit 140 can individually detect amplitudes of currents flowing in the power transmission-side coils T_{L} in the resonance circuits TT[1] to TT[n], by having a plurality of structures similar to that illustrated in FIG. 7, or by using the structures illustrated in FIG. 7 in a time-sharing manner.

In Step S26, the control circuit 160 determines whether or not the foreign object 3 is present on the power feeding table 12 based on the voltage values V_{DTEST}[1] to V_{DTEST}[n], and the foreign object detection process is finished. To determine that the foreign object 3 is present on the power feeding table 12 is referred to as foreign object presence determination. To determine that the foreign object 3 is not present on the power feeding table 12 is referred to as foreign object absence determination. When making the foreign object absence determination, the control circuit 160 determines that the power transmission circuit 130 can perform the power transmission operation so as to permit execution of the power transmission operation. When making the foreign object presence determination, the control circuit 160 determines that the power transmission circuit 130 cannot perform the power transmission operation so as to inhibit the power transmission operation. When determining that the power transmission operation can be performed, in the power transmission operation, the control circuit 160 can control the power transmission circuit 130 so that predetermined power transmission magnetic field is generated by the power transmission-side coil T_{L} in the target resonance circuit.

The method for determining whether or not the foreign object 3 is present based on the voltage values V_{DTEST}[1] to V_{DTEST}[n], which can be adopted by the control circuit 160, is the same as that described in Patent Document 1. In other words, for example, the foreign object absence determination is made only in the case where determination inequality “V_{DTEST}[i]≥V_{REF}[i]” is satisfied for all integers i satisfying “1≤i≤n”, and otherwise the foreign object presence determination is made. V_{REF}[1] to V_{REF}[n] are foreign object detection reference values that are set in advance for the individual power transmission-side coils T_{L} and are stored in the memory 150. Alternatively, for example, it is possible to make the foreign object absence determination only in the case where determination inequality “V_{DTEST}[i]≥V_{REF}” is satisfied for all integers i satisfying “1≤i≤n”, and otherwise to make the foreign object presence determination. V_{REF} is a single foreign object detection reference value that is set in advance and is stored in the memory 150.

In this way, in the foreign object detection process that is performed before the power transmission operation, the test alternating-current signal is fed from the power transmission circuit 130 to the resonance circuits TT[1] to TT[n] one after another so that the power transmission-side coils T_{L} in the resonance circuits TT[1] to TT[n] generate the test magnetic field one after another. The output values V_{D} of the load detection circuit 140 when the power transmission-side coils T_{L} in the resonance circuits TT[1] to TT[n] generate the test magnetic field are acquired one after another as the voltage values V_{DTEST}[1] to V_{DTEST}[n], and it is determined whether or not the foreign object 3 is present based on the voltage values V_{DTEST}[1] to V_{DTEST}[n].

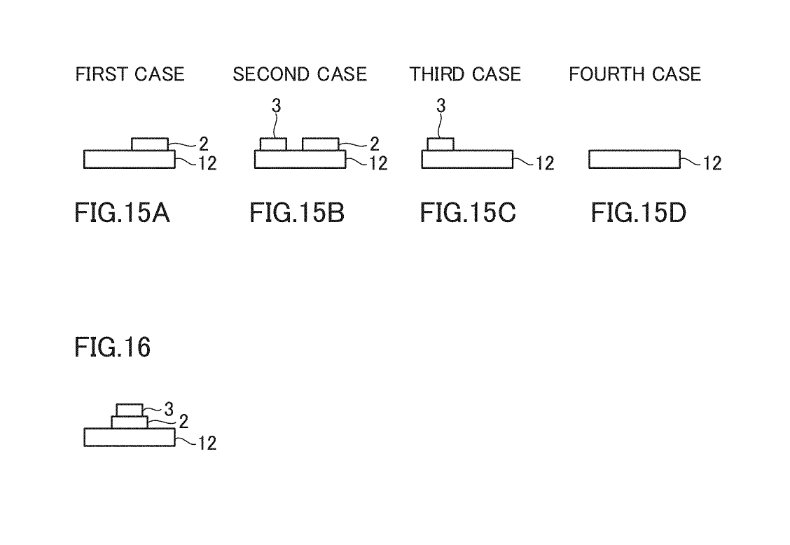

With reference to FIGS. 15A to 15D, first to fourth cases are considered. In the first case, only the electronic device 2 is present on the power feeding table 12. In the second case, the electronic device 2 and the foreign object 3 are present on the power feeding table 12. In the third case, only the foreign object 3 is present on the power feeding table 12. In the fourth case, neither the electronic device 2 nor the foreign object 3 is present on the power feeding table 12.

As described above, during the period in which the foreign object detection process is performed, the electronic device 2 is performing the f_{O} changing or short-circuiting operation. Therefore, in the first case, a load on the power transmission-side coil T_{L} becomes sufficiently light (i.e. becomes a state as if the electronic device 2 is not present on the power feeding table 12), and all the voltage values V_{DTEST}[1] to V_{DTEST}[n] become sufficiently large. Thus, the foreign object absence determination is made. On the other hand, in the second case, the resonance frequency of the resonance circuit RR is changed to the frequency f_{M} described above, or the power reception-side coil R_{L} is short-circuited, but the foreign object 3 is continued to be present as a load on the power transmission-side coil T_{L} (because the resonance frequency of the resonance circuit JJ in the foreign object 3 is maintained at the reference frequency). Therefore, a part or a whole of the voltage values V_{DTEST}[1] to V_{DTEST}[n] becomes sufficiently small, and as a result the foreign object presence determination is made.

In the third and fourth cases, the electronic device 2 that responds to the NFC communication is not present on the power feeding table 12, and hence the power transmission operation is not necessary anyway. Therefore the foreign object detection process is not performed. The power feeding device 1 can determine whether or not an electronic device 2 capable of responding to the power transfer is present on the power feeding table 12, by NFC communication. Note that the state where the foreign object 3 is present on the power feeding table 12 is not limited to the state where the foreign object 3 contacts directly with the power feeding table 12. For example, the state as illustrated in FIG. 16, in which the electronic device 2 is present on the power feeding table 12 so as to contact directly with the same, and the foreign object 3 is present on the electronic device 2, also belongs to the state where the foreign object 3 is present on the power feeding table 12, as long as the foreign object presence determination is made.

[Target Resonance Circuit Setting Process]

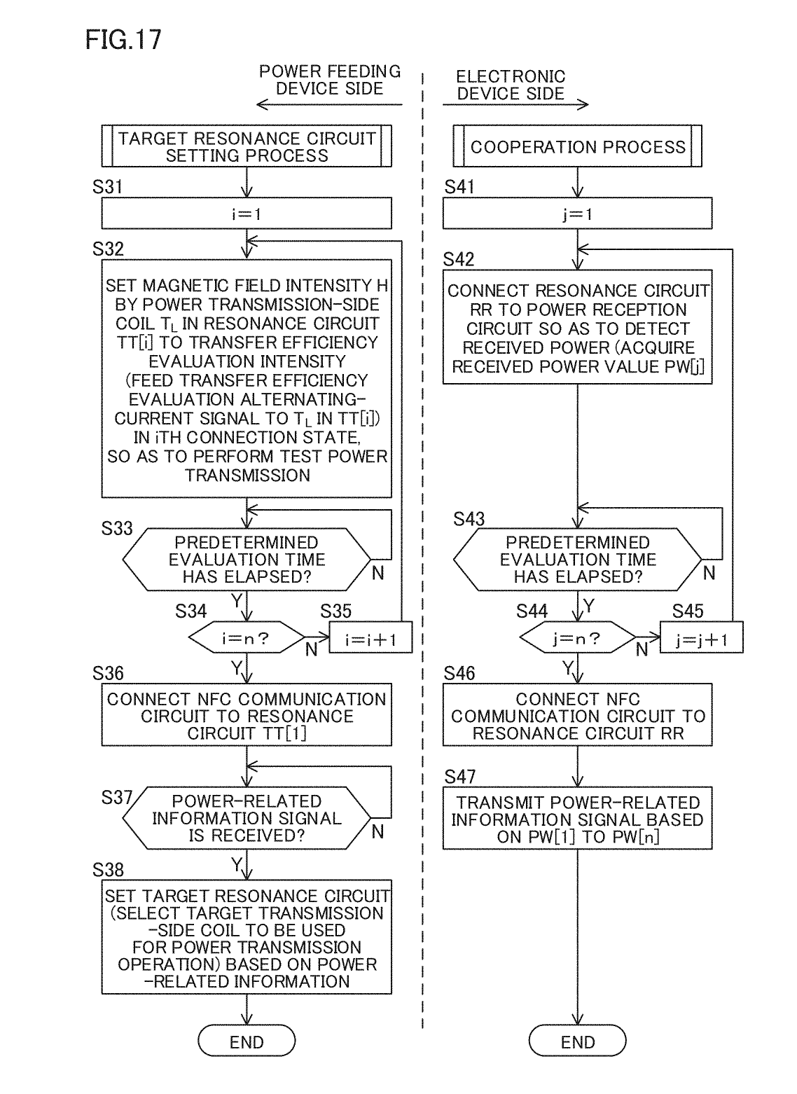

With reference to FIG. 17, a target resonance circuit setting process, which is performed by the control circuit 160 of the power feeding device 1 so that the target resonance circuit is selected and set, is described. The power transfer efficiency depends on a degree of magnetic coupling between the power transmission-side coil T_{L} and the power reception-side coil R_{L}, which are used for the power transfer. The degree of magnetic coupling depends on the shapes of the coils. If the power transmission-side coil T_{L} and the power reception-side coil R_{L} used for the power transfer have the same shape, the power transfer efficiency is maximized, but it is assumed that the power reception-side coil R_{L} have various shapes depending on the electronic device 2. Therefore, the resonance circuit TT whose power transfer efficiency is assumed to be maximized is set to the target resonance circuit in the target resonance circuit setting process. Selection and setting of the target resonance circuit are realized by cooperation between the target resonance circuit setting process and the cooperation process that is performed by the electronic device 2. In FIG. 17, a flowchart of the target resonance circuit setting process and a flowchart of the cooperation process are shown in parallel side by side.

First, the target resonance circuit setting process constituted of Steps S31 to S38 is described. In the target resonance circuit setting process, first in Step S31, 1 is substituted into the variable i. After that, in Step S32, the control circuit 160 controls the switching circuit 110 and the switches T_{SW} so as to realize the ith connection state and set the magnetic field intensity H by the power transmission-side coil T_{L} in the resonance circuit TT[i] to predetermined transfer efficiency evaluation intensity. In this way, experimental power transmission (hereinafter may be referred to as test power transmission) using the alternating magnetic field of the transfer efficiency evaluation intensity is performed from the power transmission-side coil T_{L} of the resonance circuit TT[i] to the power reception-side coil R_{L}.

As to the resonance circuit TT[i], to set the magnetic field intensity H to the transfer efficiency evaluation intensity means to control the power transmission circuit 130 so that a predetermined transfer efficiency evaluation alternating-current signal (transfer efficiency evaluation alternating current) is supplied to the resonance circuit TT[i], and hence to control the power transmission-side coil T_{L} of the resonance circuit TT[i] to generate the alternating magnetic field having the transfer efficiency evaluation intensity and oscillating at the reference frequency. When performing the target resonance circuit setting process before the foreign object detection process prior to the power transfer is performed (before the foreign object absence determination is made), similarly to the test intensity, in order to prevent the presentable foreign object 3 from being broken down, the transfer efficiency evaluation intensity is set to be smaller than the intensity of the magnetic field generated by the power transmission-side coil T_{L} when the power transfer is performed (i.e. when the power transmission operation is performed) (i.e. the magnetic field intensity of the power transmission magnetic field, which is e.g. 45 to 60 A/m). For example, the transfer efficiency evaluation intensity is within a range from the lower limit of 1.5 A/m to the upper limit of 7.5 A/m of the communication magnetic field intensity. In this case, the transfer efficiency evaluation intensity may be the same as or different from the test intensity in the foreign object detection process. When performing the target resonance circuit setting process after the foreign object detection process prior to the power transfer is performed and the foreign object absence determination is made, the transfer efficiency evaluation intensity may be the same as or smaller than the magnetic field intensity of the power transmission magnetic field, or may be the same as the test intensity.

The power transmission-side coil T_{L} of the resonance circuit TT[i] generates the alternating magnetic field of the transfer efficiency evaluation intensity for only a predetermined evaluation time. When the evaluation time has elapsed from the generation, the process proceeds from Step S32 to Step S34 via Step S33. In Step S34, the control circuit 160 determines whether or not “i=n” is satisfied. If “i=n” is satisfied, the process proceeds to Step S36, but otherwise 1 is added to the variable i in Step S35, and the process returns to Step S32 so that Step S32 is performed repeatedly. Therefore, at time point when reaching the Step S36, total n times of the test power transmission is finished, using the resonance circuits TT[1] to TT[n] one after another.

The control circuit 160 connects the NFC communication circuit 120 to the resonance circuit TT[1] in Step S36, and then waits for reception of the power-related information signal in Step S37. When the signal is received, the control circuit 160 sets the target resonance circuit based on power-related information included in the power-related information signal in Step S38 (in other words, the control circuit 160 selects the target resonance circuit from the resonance circuits TT[1] to TT[n]). As the power transmission operation is performed using the target resonance circuit, setting and selecting of the target resonance circuit corresponds to selecting the power transmission-side coil T_{L} (target power transmission-side coil) to be used for the power transmission operation from the power transmission-side coil T_{L} in the resonance circuits TT[1] to TT[n].

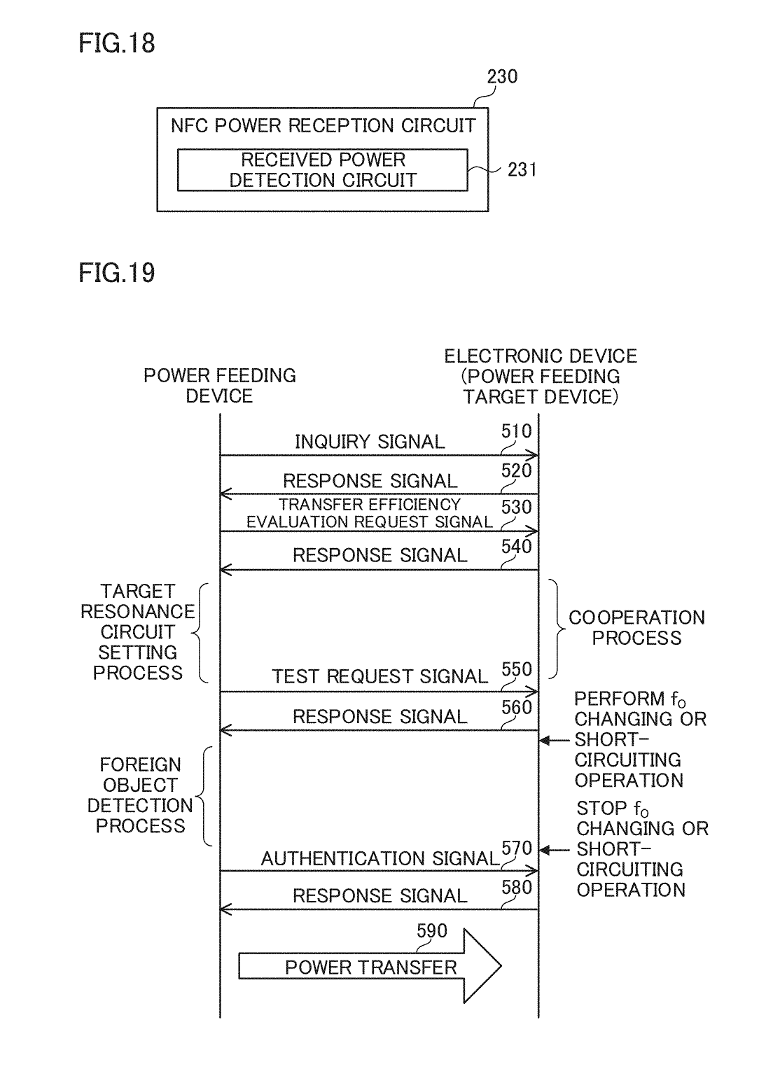

Next, the cooperation process constituted of Steps S41 to S47 is described. Note that when the cooperation process is performed, the f_{O} changing or short-circuiting operation is not performed. In the target resonance circuit setting process, 1 is substituted into the variable j first in Step S41. After that, in Step S42, the resonance circuit RR is connected to the power reception circuit 230 under control by the control circuit 260, and a received power by the resonance circuit RR at this time is detected. As illustrated in FIG. 18, the power reception circuit 230 includes a received power detection circuit 231 that detects the received power by the resonance circuit RR (in other words, the received power by the power reception-side coil R_{L}). As known well, electric power supplied from the resonance circuit RR to a load that consumes the received power by the resonance circuit RR (load including battery 21 and the functional circuit 22 in the example of FIG. 3) may be detected as the received power by detection of voltage and current. A value indicating the received power detected as for the variable j is referred to as a received power value PW[j].

When the evaluation time, in which one test power transmission is performed, has elapsed after certain test power transmission is started, the process proceeds to Step S44 from Step S42 via Step S43. In Step S44, the control circuit 260 determines whether or not “j=n” holds. If “j=n” holds, the process proceeds to Step S46. Otherwise, 1 is added to the variable j in Step S45, and the process returns to Step S42 so that Step S42 is performed repeatedly. Therefore, at time point when reaching Step S46, received power values PW[1] to PW[n] are acquired. After connecting the NFC communication circuit 220 to the resonance circuit RR in Step S46, the control circuit 260 generates power-related information based on the received power values PW[1] to PW[n] in Step S47, and transmits the power-related information signal containing the power-related information to the power feeding device 1 by NFC communication.

The power-related information contains information that specifies the power transmission-side resonance circuit TT and the power transmission-side coil T_{L} corresponding to a maximum received power value among the received power values PW[1] to PW[n], and the control circuit 160 selects and sets the power transmission-side resonance circuit TT corresponding to the maximum received power value as the target resonance circuit.

For example, if the received power value PW[s] is maximum among the received power values PW[1] to PW[n] (s is a natural number smaller than or equal to n), the value of “s” is the power-related information. In this case, the control circuit 160 of the power feeding device 1 determines that a resonance circuit TT[s] used for the sth test power transmission can realize the maximum power transfer efficiency based on the value of “s” contained in the power-related information, and sets the resonance circuit TT[s] as the target resonance circuit. Alternatively, for example, it is possible to contain the received power values PW[1] to PW[n] in the power-related information. In this case, the control circuit 160 of the power feeding device 1 compares the received power values PW[1] to PW[n] contained in the power-related information. If the received power value PW[s] is maximum among them (s is a natural number smaller than or equal to n), the control circuit 160 determines that the resonance circuit TT[s] used for the sth test power transmission can realize the maximum power transfer efficiency, and sets the resonance circuit TT[s] as the target resonance circuit.

When the power feeding device 1 performs the target resonance circuit setting process, the NFC communication between the devices 1 and 2 is appropriately used so that the timers of the devices 1 and 2 are set in a synchronized manner between the devices 1 and 2. Using the timer, the control circuit 260 of the electronic device 2 recognizes periods in which the first to the nth test power transmission are performed, respectively. Alternatively, it is possible to configure so that the devices 1 and 2 share the information that the test power transmission is performed via the NFC communication in each test power transmission.

[Signal Communication Until Power Transfer: FIG. 19]

With reference to FIG. 19, signal communication between the devices 1 and 2 until the power transfer is performed is described. In the following description, unless otherwise noted, it is supposed that the electronic device 2 is present on the power feeding table 12 in the reference position state (FIG. 1B).

First, the power feeding device 1 is the transmitting side while the electronic device 2 is the receiving side, and the power feeding device 1 (IC 100) transmits an inquiry signal 510 to the device on the power feeding table 12 (hereinafter also referred to as a power feeding target device) via the NFC communication. The power feeding target device includes the electronic device 2 and can include the foreign object 3. The inquiry signal 510 includes, for example, a signal inquiring unique identification information of the power feeding target device, a signal inquiring whether or not the power feeding target device is in a state where the NFC communication can be performed, and a signal inquiring whether or not the power feeding target device can receive power or is requesting power transmission.

After receiving the inquiry signal 510, the electronic device 2 (IC 200) sends a response signal 520 responding to inquiry content of the inquiry signal 510 to the power feeding device 1 via the NFC communication. After receiving the response signal 520, the power feeding device 1 (IC 100) analyzes the response signal 520. If the power feeding target device can perform the NFC communication and can receive power or is requesting power transmission, the power feeding device 1 transmits a transfer efficiency evaluation request signal 530 to the power feeding target device by NFC communication. After receiving the transfer efficiency evaluation request signal 530, the electronic device 2 (IC 200) transmits a response signal 540 responding to the transfer efficiency evaluation request signal 530 to the power feeding device 1 via the NFC communication.

After receiving the response signal 540, the power feeding device 1 (IC 100) performs the target resonance circuit setting process described above. After transmitting the response signal 540, the electronic device 2 performs the above-mentioned cooperation process in synchronization with the target resonance circuit setting process. When the signals 530 and 540 are transmitted and received, it is preferred to set the timers of the devices 1 and 2 so that timings when the first to the nth test power transmissions are performed are synchronized between the devices 1 and 2.

When the target resonance circuit setting process is finished, the power feeding device 1 (IC 100) transmits a test request signal 550 to the power feeding target device by NFC communication. After receiving the test request signal 550, the electronic device 2 (IC 200) as the power feeding target device transmits the response signal 560 responding to the test request signal 550 to the power feeding device 1 by NFC communication and performs the f_{O} changing or short-circuiting operation (resonance frequency changing operation or the coil short-circuiting operation) without delay. The test request signal 550 is a signal instructing to perform the f_{O} changing or short-circuiting operation, for example, and the control circuit 260 of the electronic device 2 controls the resonance state changing circuit 240 to perform the f_{O} changing or short-circuiting operation when receiving the test request signal 550. Before receiving the test request signal 550, the f_{O} changing or short-circuiting operation is not performed. The test request signal 550 may be any signal as long as it triggers execution of the f_{O} changing or short-circuiting operation.

After receiving the response signal 560, the power feeding device 1 (IC 100) performs the foreign object detection process described above. During a period in which the foreign object detection process is performed, the electronic device 2 (IC 200) continues to perform the f_{O} changing or short-circuiting operation. Specifically, the electronic device 2 (IC 200) uses the timer so as to stop the f_{O} changing or short-circuiting operation after maintaining execution of the f_{O} changing or short-circuiting operation for a period of time corresponding to an execution period of the foreign object detection process.

When determining that the foreign object 3 is not present on the power feeding table 12 in the foreign object detection process, the power feeding device 1 (IC 100) transmits an authentication signal 570 to the power feeding target device by NFC communication. The authentication signal 570 includes a signal notifying the power feeding target device that the power transmission is going to be performed, for example. After receiving the authentication signal 570, the electronic device 2 (IC 200) transmits a response signal 580 responding to the authentication signal 570 to the power feeding device 1 by NFC communication. The response signal 580 includes a signal informing that content of the authentication signal 570 is recognized or a signal giving permission to the content of the authentication signal 570, for example. After receiving the response signal 580, the power feeding device 1 (IC 100) connects the power transmission circuit 130 to the set target resonance circuit so as to perform the power transmission operation, and thus power transfer 590 is realized.

In the first case of FIG. 15A, the power transfer 590 is performed in the flow described above. However, in the second case of FIG. 15B, although the process proceeds until the transmission and reception of the response signal 560, the power transfer 590 is not performed, because it is determined that the foreign object is present on the power feeding table 12 in the foreign object detection process.

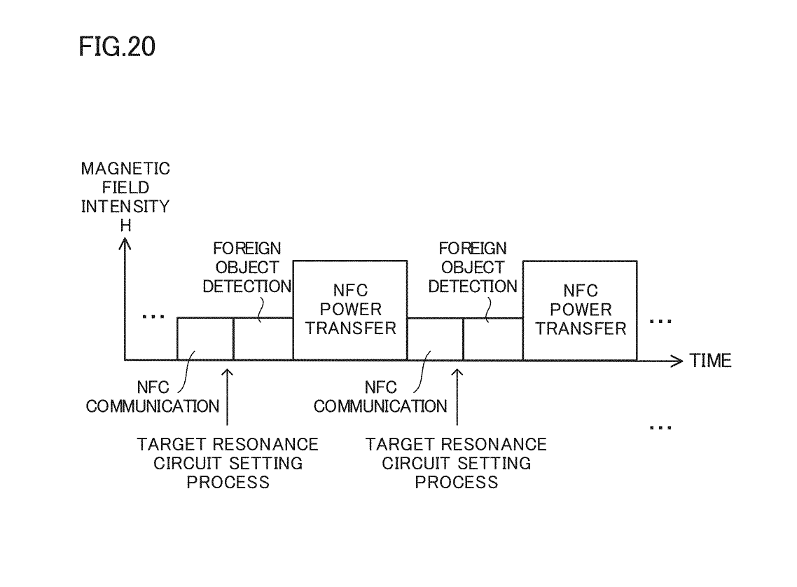

The power transfer 590 of one time may be performed only for a predetermined period of time, and a series of processes from the transmission of the inquiry signal 510 to the power transfer 590 may be performed repeatedly. In reality, as illustrated in FIG. 20, the NFC communication, the foreign object detection process, and the power transfer (NFC power transfer) can be performed sequentially and repeatedly. In other words, in the non-contact power feeding system, the operation of performing the NFC communication, the operation of performing the foreign object detection process, and the operation of performing the power transfer (NFC power transfer) can be performed sequentially and repeatedly in a time-sharing manner. In the example of FIG. 20, the target resonance circuit setting process is performed before the foreign object detection process for each set of the NFC communication, the foreign object detection process, and the power transfer (for each series of process from the transmission of the inquiry signal 510 to the power transfer 590).

[General Operation Flowchart]

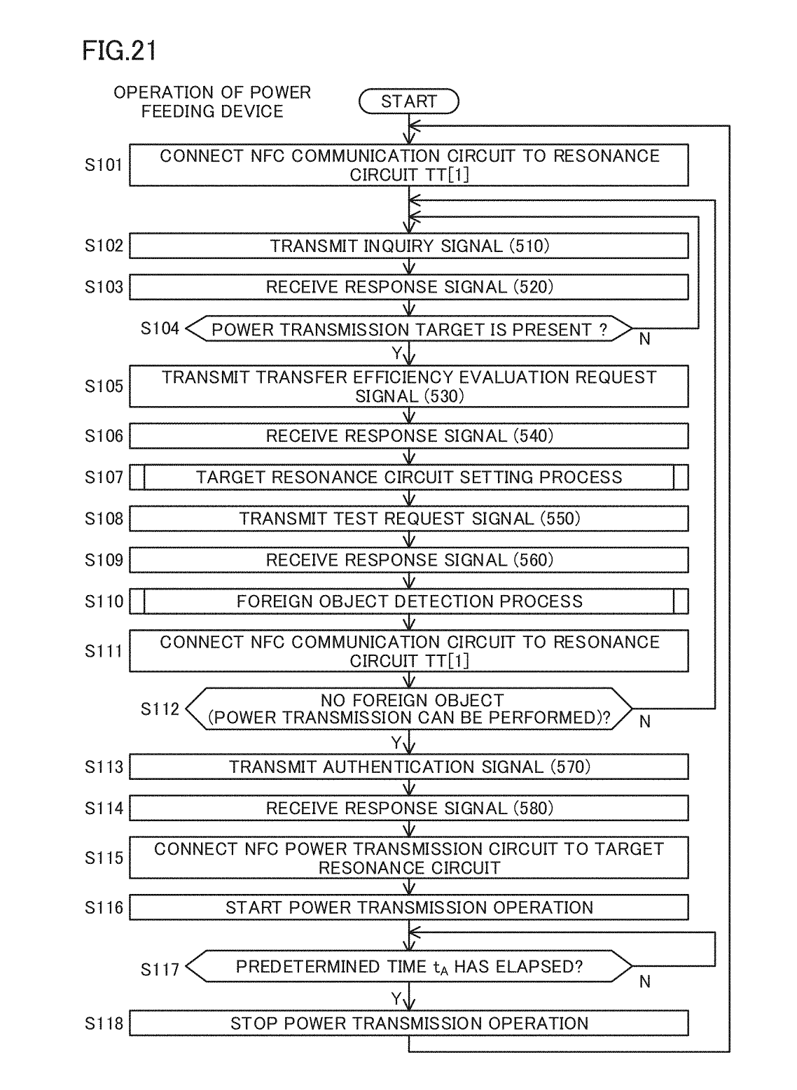

Next, a flow of general operation of the power feeding device 1 is described. FIG. 21 is a general operation flowchart of the power feeding device 1 according to the first embodiment. The operations of the communication circuit 120 and the power transmission circuit 130 are performed under control by the control circuit 160.

When the power feeding device 1 is activated, first in Step S101, the control circuit 160 connects the communication circuit 120 to the resonance circuit TT[1] by controlling the switching circuit 110. In the next Step S102, the control circuit 160 transmits the inquiry signal 510 to the power feeding target device by NFC communication using the communication circuit 120 and the resonance circuit TT[1], and then waits for reception of the response signal 520 in Step S103. When the communication circuit 120 receives the response signal 520, the control circuit 160 analyzes the response signal 520. If the power feeding target device can perform the NFC communication and can receive power or is requesting power transmission, the control circuit 160 determines that there is a power transmission target (Y in Step S104) and proceeds to Step S105. Otherwise (N in Step S104), the process returns to Step S102.

In Step S105, the control circuit 160 transmits the transfer efficiency evaluation request signal 530 to the power feeding target device by NFC communication using the communication circuit 120 and the resonance circuit TT[1], and then in Step S106, and waits for reception of the response signal 540. When the communication circuit 120 receives the response signal 540, the control circuit 160 performs the above-mentioned target resonance circuit setting process in Step S107.

After finishing the target resonance circuit setting process, the control circuit 160 transmits the test request signal 550 to the power feeding target device by NFC communication using the communication circuit 120 and the resonance circuit TT[1] in Step S108. After that, in Step S109, the control circuit 160 waits for reception of the response signal 560. When the communication circuit 120 receives the response signal 560, the control circuit 160 performs the above-mentioned foreign object detection process in the next Step S110.

In the foreign object detection process, the power transmission circuit 130 is connected to the resonance circuit TT (see FIG. 14), and hence the control circuit 160 connects the communication circuit 120 to the resonance circuit TT[1] by controlling the switching circuit 110 in Step S111 after the foreign object detection process is finished, and proceeds to Step S112. If the foreign object presence determination is made in the foreign object detection process in Step S110, the process returns from Step S112 to Step S102. If the foreign object absence determination is made, the process proceeds from Step S112 to Step S113.

In Step S113, the control circuit 160 transmits the authentication signal 570 to the power feeding target device by NFC communication using the communication circuit 120 and the resonance circuit TT[1], and then in Step S114, the control circuit 160 waits for reception of the response signal 580. When the communication circuit 120 receives the response signal 580, the control circuit 160 connects the power transmission circuit 130 to the target resonance circuit by controlling the switching circuit 110 in Step S115 and proceeds to Step S116. The control circuit 160 starts the power transmission operation using the power transmission circuit 130 and the target resonance circuit in Step S116, and then proceeds to Step S117.

The control circuit 160 measures elapsed time from the time point when the power transmission operation is started, and compares the elapsed time with a predetermined time t_{A} in Step S117. The comparison process of Step S117 is repeated until the elapsed time reaches the time t_{A}. When the elapsed time reaches the time t_{A} (Y in Step S117), the process proceeds to Step S118. In Step S118, the control circuit 160 stops the power transmission operation by the power transmission circuit 130 and returns to Step S101 so that the process described above is repeated.

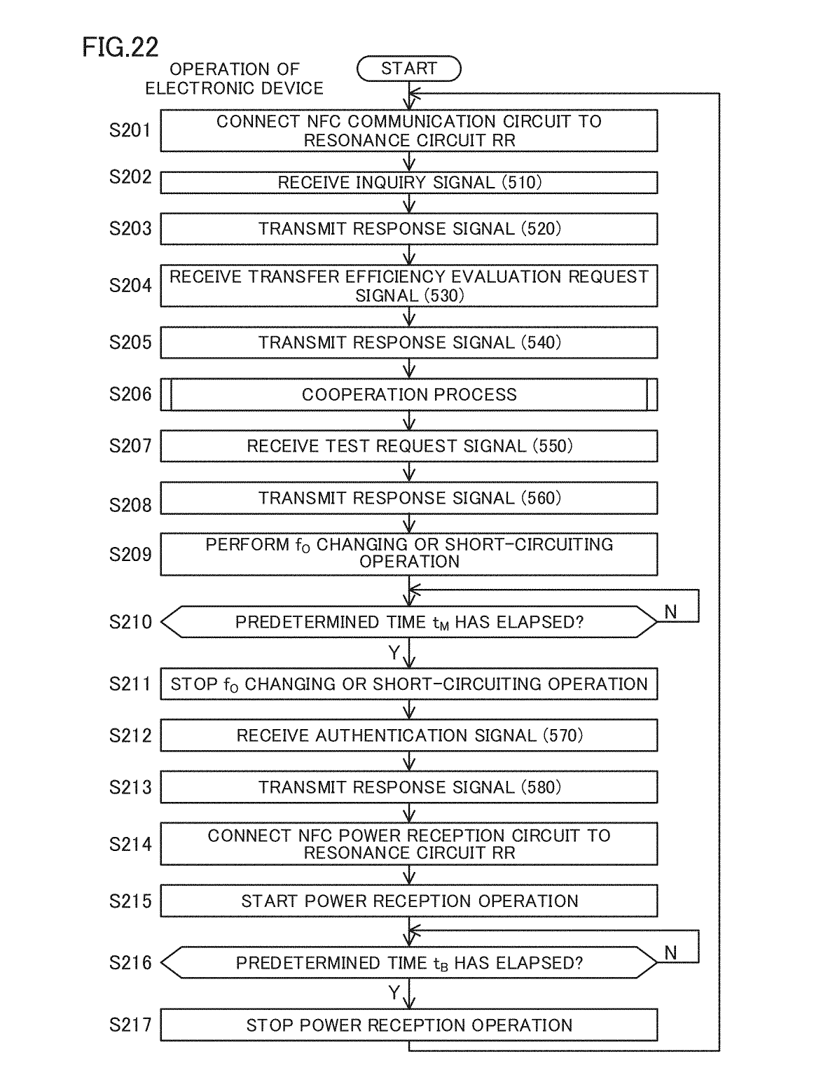

Next, a flow of general operation of the electronic device 2 is described. FIG. 22 is a general operation flowchart of the electronic device 2 according to a second embodiment, and the process starting from Step S201 is performed along with the operation of the power feeding device 1. The operations of the communication circuit 220 and the power reception circuit 230 are performed under control by the control circuit 260.

When the electronic device 2 is activated, first in Step S201, the control circuit 260 connects the communication circuit 220 to the resonance circuit RR by controlling the switching circuit 210. When the electronic device 2 is activated, the f_{O} changing or short-circuiting operation is not performed. In the next Step S202, the control circuit 260 waits for reception of the inquiry signal 510 using the communication circuit 220. When the communication circuit 220 receives the inquiry signal 510, the control circuit 260 analyzes the inquiry signal 510 in Step S203, so as to generate the response signal 520, and transmits the response signal 520 to the power feeding device 1 by NFC communication using the communication circuit 220. In this case, the control circuit 260 checks the state of the battery 21. If the battery 21 is not fully charged and no abnormality is observed in the battery 21, a signal indicating that power can be received or that power transmission is requested is included in the response signal 520. On the other hand, if the battery 21 is fully charged, or if an abnormality is observed in the battery 21, a signal indicating that power cannot be received is included in the response signal 520.

When the communication circuit 220 receives the transfer efficiency evaluation request signal 530 in Step S204 after Step S203, the process proceeds to Step S205. In Step S205, the control circuit 260 transmits the response signal 540 to the power feeding device 1 by NFC communication using the communication circuit 220, and performs the cooperation process described above in the next Step S206.

After the cooperation process is finished, when the communication circuit 220 receives the test request signal 550 in Step S207, the process proceeds to Step S208. In Step S208, the control circuit 260 transmits the response signal 560 to the power feeding device 1 by NFC communication using the communication circuit 220, and performs the f_{O} changing or short-circuiting operation using the resonance state changing circuit 240 in the next Step S209. In other words, the resonance frequency f_{O} is changed from the reference frequency to the frequency f_{M}, or the power reception-side coil R_{L} is short-circuited. The control circuit 260 measures elapsed time from start of the f_{O} changing or short-circuiting operation (Step S210) and stops the f_{O} changing or short-circuiting operation when the elapsed time reaches a predetermined period of time t_{M} (Step S211). In other words, the resonance frequency f_{O} is restored to the reference frequency, or the short-circuit of the power reception-side coil R_{L} is canceled. After that, the process proceeds to Step S212. The period of time t_{M} is set in advance so that the execution of the f_{O} changing or short-circuiting operation is maintained during a period in which the power feeding device 1 performs the foreign object detection process (i.e. during a period in which the test magnetic field is generated), and so that the f_{O} changing or short-circuiting operation is stopped without delay when the period ends. The period of time t_{M} may be designated in the test request signal 550.

In Step S212, the control circuit 260 uses the communication circuit 220 and waits for reception of the authentication signal 570. When the communication circuit 220 receives the authentication signal 570, the control circuit 260 transmits the response signal 580 responding to the authentication signal 570 to the power feeding device 1 by NFC communication using the communication circuit 220 in Step S213. Note that if the foreign object 3 is present on the power feeding table 12, the authentication signal 570 is not transmitted from the power feeding device 1 (see Step S112 in FIG. 21), and hence it is preferred to return to Step S201 if the authentication signal 570 is not received for a certain period of time in Step S212.

After the response signal 580 is transmitted, the control circuit 260 connects the power reception circuit 230 to the resonance circuit RR by controlling the switching circuit 210 in Step S214, and in the next Step S215, the control circuit 260 controls the power reception circuit 230 to start the power reception operation. The control circuit 260 measures elapsed time from the time point when the power reception operation starts, and compares the elapsed time with a predetermined time t_{B} (Step S216). Further, when the elapsed time reaches the time t_{B} (Y in Step S216), the control circuit 260 stops the power reception operation in Step S217 and returned to Step S201.

The time t_{B} is determined in advance or designated in the authentication signal 570 so that the period in which the power reception operation is performed is substantially equal to the period in which the power feeding device 1 performs the power transmission operation. After starting the power reception operation, the control circuit 260 monitors charging current for the battery 21. It may be configured to determine that the power transmission operation is finished when the charging current value becomes a predetermined value or less, so as to stop the power reception operation, and to proceed to the Step S201.

It is assumed that the power reception-side coil R_{L} has various shapes depending on the electronic device 2. In this embodiment, the power transmission-side coil T_{L} having the highest power transfer efficiency (power transmission-side coil T_{L} in the target resonance circuit) is used to perform the power transfer, and hence the high efficiency power transfer can be realized according to the shape of the power reception-side coil R_{L}. In addition, when the foreign object 3 is placed on the power feeding table 12 by error, the power transmission operation is not performed as a result of the foreign object detection process, and hence it is possible to prevent the foreign object 3 from being broken or damaged due to execution of the power transmission operation. Further, because a plurality of power transmission-side coils T_{L} having different shapes (including different sizes) are used to perform the foreign object detection process, it is possible to accurately detect whether or not the foreign object 3 is present, which can include the coil J_{L} (antenna coil) having various shapes. In this way, the plurality of power transmission-side coils T_{L} contribute to higher efficiency of the power transfer and higher accuracy of the foreign object detection. In other words, the plurality of power transmission-side coils T_{L} can be used for realizing higher efficiency of the power transfer as well as higher accuracy of the foreign object detection.

Note that in the flowcharts of FIGS. 21 and 22, execution timing of the target resonance circuit setting process and the cooperation process may be changed to any timing before starting the power transmission operation. For example, it is possible to perform the target resonance circuit setting process and the cooperation process after the foreign object absence determination is made in the foreign object detection process.

### Second Embodiment

The second embodiment of the present invention is described. The second embodiment is an embodiment based on the first embodiment. As to items that are not particularly described in the second embodiment, description in the first embodiment is applied also to the second embodiment as long as no contradiction arises.

In the electronic device 2 according to the second embodiment, the memory 250 (see FIG. 5) includes a ROM that stores power reception-side shape-related information based on the shape of the power reception-side coil R_{L} in a nonvolatile manner. The power reception-side shape-related information is information that identifies the shape of the power reception-side coil R_{L}.

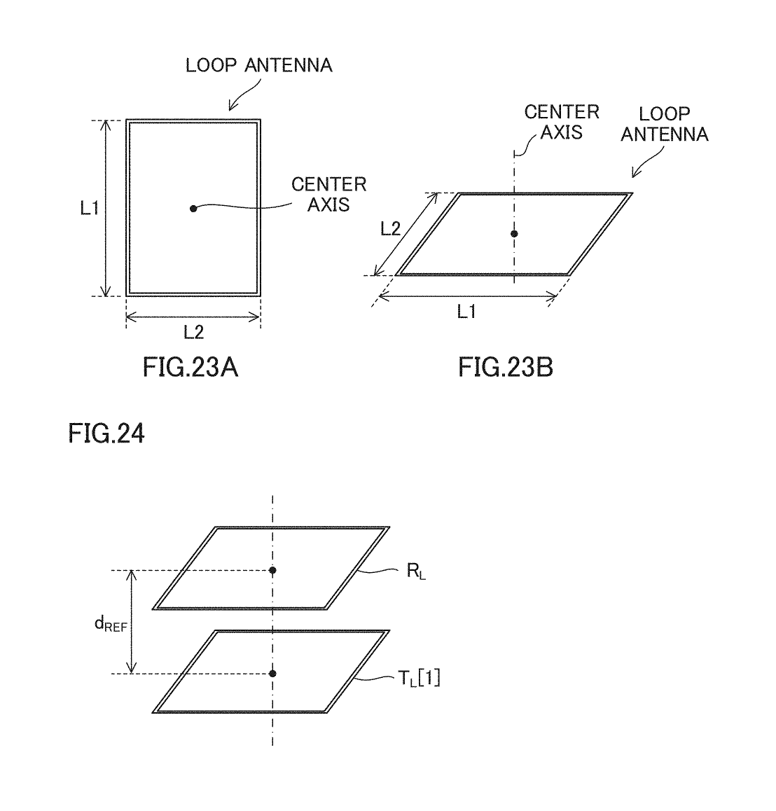

With reference to FIGS. 23A and 23B, in this embodiment, for specific description, each of the power transmission-side coils T_{L} and the power reception-side coil R_{L} constitutes a loop antenna. On a loop surface of the loop antenna as each power transmission-side coil T_{L} or power reception-side coil R_{L} (a surface on which a coil winding is disposed), the loop antenna has a contour of substantially rectangular shape, and lengths of a long side and a short side of the rectangular shape are denoted by L1 and L2, respectively. Note that if the rectangular shape is a square, the long side is the same as the short side, and each of L1 and L2 denotes the length of one side of the square. In the coil as the loop antenna (the power transmission-side coil T_{L} or the power reception-side coil R_{L}), the coil is wound about the center axis, and therefore the center axis is perpendicular to the loop surface of the loop antenna. Further, the power reception-side shape-related information includes information indicating the lengths L1 and L2 as the long side and the short side of the power reception-side coil R_{L}.

In addition, the memory 150 of the power feeding device 1 includes a ROM that stores the power transmission-side shape-related information in a nonvolatile manner. The power transmission-side shape-related information is information based on the shapes of the power transmission-side coils T_{L} in the resonance circuits TT[1] to TT[n], and contains information that identifies a shape of the power transmission-side coil T_{L} for each power transmission-side coil T_{L}. The power transmission-side shape-related information includes information indicating lengths L1 and L2 of the long side and short side of the power transmission-side coil T_{L} in each of the resonance circuits TT[1] to TT[n]. Note that the power transmission-side coil T_{L} of the resonance circuit TT[i] may be particularly referred to as “T_{L}[i]” (see FIG. 13).

The control circuit 160 according to the second embodiment acquires the power reception-side shape-related information from the electronic device 2 by NFC communication, prior to execution of the power transmission operation. Further, based on the power reception-side shape-related information, while also referring to the power transmission-side shape-related information, the control circuit 160 identifies (selects) the power transmission-side coil T_{L} that is expected to have the maximum power transfer efficiency from the power transmission-side coils T_{L}[1] to T_{L}[n], and sets the resonance circuit TT including the identified (selected) power transmission-side coil T_{L} as the target resonance circuit.

With reference to FIG. 24, a method for identifying (selecting) the power transmission-side coil T_{L} that is expected to have the maximum power transfer efficiency from the power transmission-side coils T_{L}[1] to T_{L}[n] is described. It is assumed that the center axis of the power transmission-side coil T_{L}[1] is identical to the center axis of the power reception-side coil R_{L}, and that the loop surface of the power transmission-side coil T_{L}[1] and the loop surface of the power reception-side coil R_{L} are disposed in parallel so that the long side of the power transmission-side coil T_{L}[1] faces the long side of the power reception-side coil R_{L}, and that distance between the loop surfaces is a predetermined distance d_{REF}, and that space between the power transmission-side coil T_{L}[1] and the power reception-side coil R_{L} is filled with air. On this assumption, the control circuit 160 derives coupling coefficient (magnetic coupling coefficient) between the power transmission-side coil T_{L}[1] and the power reception-side coil R_{L}, based on the lengths L1 and L2 of the long side and short side of the power transmission-side coil T_{L}[1], and the lengths L1 and L2 of the long side and short side of the power reception-side coil R_{L}. When the shapes of the two coils are determined on the assumption described above, the coupling coefficient can be derived using a known calculation equation. Although derivation of the coupling coefficient for the power transmission-side coil T_{L}[1] is described above, the coupling coefficient between the power transmission-side coil T_{L} and the power reception-side coil R_{L} can be derived for each of the power transmission-side coils T_{L}[1] to T_{L}[n]. The derived coupling coefficient between the power transmission-side coil T_{L}[i] and the power reception-side coil R_{L} is denoted by symbol CF[i].

An actual coupling coefficient has various values depending on an arrangement state of the actual electronic device 2, and it is supposed that the power transfer efficiency becomes higher when the power transmission-side coil T_{L} having a larger coupling coefficient derived as described above is used to perform the power transfer. Therefore, the control circuit 160 sets the resonance circuit TT including the power transmission-side coil T_{L} corresponding to the maximum coupling coefficient among the derived coupling coefficient CF[1] to CF[n] as the target resonance circuit. In other words, for example, if the coupling coefficient CF[1] is maximum among the coupling coefficient CF[1] to CF[n], the resonance circuit TT[1] is set as the target resonance circuit. If the coupling coefficient CF[2] is maximum, the resonance circuit TT[2] is set as the target resonance circuit.

The second embodiment is the same as the first embodiment except that the method for setting the target resonance circuit is different between them. Along with changing the method for setting the target resonance circuit, it is not necessary in the second embodiment to perform the target resonance circuit setting process and the cooperation process illustrated in FIG. 17. Although it is supposed that the power transmission-side coil T_{L} and the power reception-side coil R_{L} have rectangular contours, the coupling coefficient is determined based on the concept described above also in a case where both or one of them has a contour shape other than the rectangular shape (e.g. a circular shape). For example, supposing that the power transmission-side coil T_{L}[1] and the power reception-side coil R_{L} are disposed with air space of the predetermined distance d_{REF} between them, the potential maximum value of the coupling coefficient between the power transmission-side coil T_{L}[1] and the power reception-side coil R_{L} is derived as the coupling coefficient CF[1]. The same is true for a coupling coefficient between other power transmission-side coil T_{L} and the power reception-side coil R_{L}.

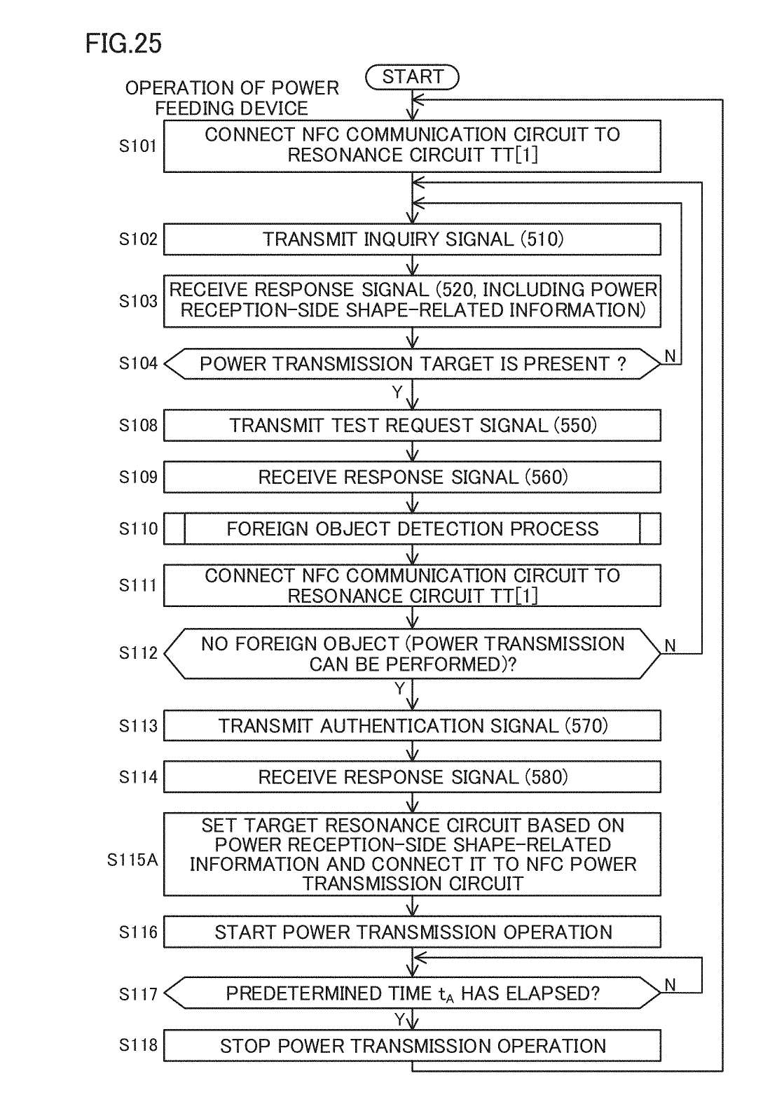

FIG. 25 is a general operation flowchart of the power feeding device 1 according to the second embodiment. The flowchart of FIG. 25 is partially modified from the flowchart of FIG. 21, and only a difference between them is noted while description of overlapping parts is omitted as a general rule. In the power feeding device 1, after Steps S101 to S104, the process proceeds to Step S108 without performing the process of Steps S105 to S107 illustrated in FIG. 21. However, the response signal 520 received in Step S103 contains the power reception-side shape-related information. After proceeding to Step S108, the process of Steps S108 to S114 is performed, and the process proceeds to Step S115A. In Step S115A, the control circuit 160 sets the target resonance circuit using the power reception-side shape-related information according to the method described above in the second embodiment, and connects the power transmission circuit 130 to the target resonance circuit by controlling the switching circuit 110. The operation after setting the target resonance circuit including the process of Steps S116 to S118 is the same as in the first embodiment.

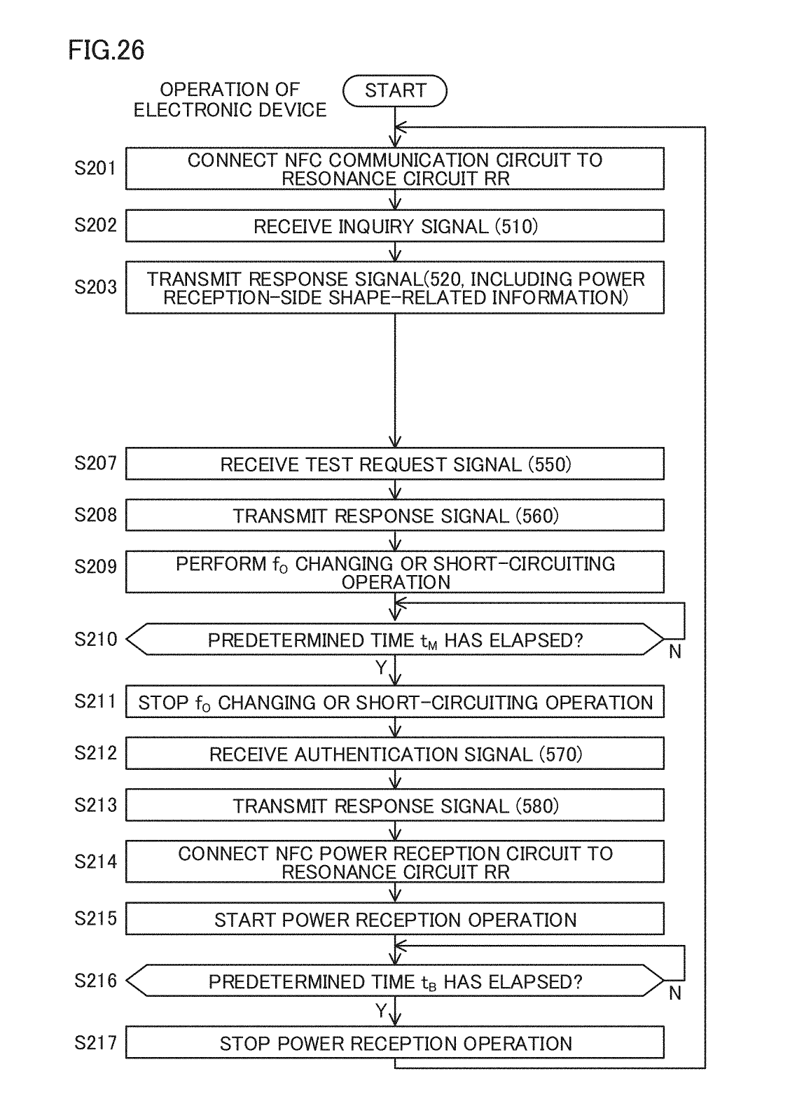

FIG. 26 is a general operation flowchart of the electronic device 2 according to the second embodiment. The flowchart of FIG. 26 is partially modified from the flowchart of FIG. 22, and only a difference between them is noted while description of overlapping parts is omitted as a general rule. In the electronic device 1, after Steps S201 to S203, the process proceeds to Step S207 without performing the process of Steps S204 to S206 illustrated in FIG. 22. However, the control circuit 260 of the electronic device 2 controls so that the response signal 520 transmitted in Step S203 contains the power reception-side shape-related information. The operation after proceeding to Step S207 is the same as in the first embodiment.

Note that the power reception-side shape-related information may be any information as long as the control circuit 160 can specify the shape of the power reception-side coil R_{L} from the information. For example, if the power reception-side coil R_{L} has the same shape as the antenna coil AT1, and the control circuit 160 recognizes the shape of the antenna coil AT1 in advance, the power reception-side shape-related information may be information indicating that the power reception-side coil R_{L} has the same shape as antenna coil AT1. The same is true in the case where the power reception-side coil R_{L} has the same shape as the antenna coil AT2 or the like.

In addition, for example, if the power transmission-side coil T_{L}[1] has the same shape as the antenna coil AT1 and the power reception-side shape-related information contains information indicating that the power reception-side coil R_{L} has the same shape as the antenna coil AT1, the resonance circuit TT[1] may be set as the target resonance circuit without deriving the coupling coefficient.

This is further described below. As a typical example, it is supposed that “n=6” holds, and the power transmission-side coils T_{L}[1] to T_{L}[6] have the same shape as the antenna coils AT1 to AT6, respectively. In this case, if the specification in which the power reception-side coil R_{L} of the electronic device 2 is restricted to have the same shape as one of the antenna coils AT1 to AT6 is defined in the non-contact power feeding system, the power reception-side shape-related information is sufficient to be information that identifies which one of the antenna coils AT1 to AT6 has the same shape as the power reception-side coil R_{L}. If the power reception-side shape-related information indicating that the power reception-side coil R_{L} has the same shape as the antenna coil AT1 is received, the control circuit 160 sets the resonance circuit TT[1] as the target resonance circuit. If the power reception-side shape-related information indicating that the power reception-side coil R_{L} has the same shape as the antenna coil AT2 is received, the control circuit 160 sets the resonance circuit TT[2] as the target resonance circuit. The same is true in the case where the power reception-side coil R_{L} has the same shape as the antenna coil AT3 or other antenna coil.

In addition, after setting the target resonance circuit to start the power transmission operation by the method of this embodiment, if the control circuit 260 determines that the received power detected during the power transmission operation is abnormally small, a signal indicating the detection result may be transmitted from the electronic device 2 to the power feeding device 1. Further, when the signal is received by the power feeding device 1, it is preferred to reset the resonance target circuit by the method described above in the first embodiment.

### Third Embodiment

A third embodiment of the present invention is described. The third embodiment is based on the first and second embodiments. As to items that are not particularly described in the third embodiment, description in the first or second embodiment is applied also to the third embodiment as long as no contradiction occurs. Note that in the third embodiment, the number of resonance circuits TT disposed in the power feeding device 1 is three or larger.

The power transmission-side coil T_{L} included in the target resonance circuit can be referred to as a target power transmission-side coil. The control circuit 160 may identify each of two or more power transmission-side coils T_{L} that are part of the power transmission-side coils T_{L}[1] to T_{L}[n] as candidates of the target power transmission-side coil, based on the power reception-side shape-related information, and may extract each of the resonance circuits TT including the candidates of the target power transmission-side coil as a candidate of the target resonance circuit.

For example, after deriving the coupling coefficient CF[1] to CF[n] according to the method described in the second embodiment, the control circuit 160 identifies the maximum value among the coupling coefficients CF[1] to CF[n]. If there are two or more coupling coefficients having the maximum value (hereinafter also referred to as a maximum coupling coefficient), two or more power transmission-side coils T_{L} corresponding to two or more maximum coupling coefficients are included in the candidates of the target power transmission-side coil. In addition, a coupling coefficient different from the maximum coupling coefficient (hereinafter referred to as a non-maximum coupling coefficient) is compared with the maximum coupling coefficient, and the power transmission-side coil T_{L} corresponding to the non-maximum coupling coefficient whose difference from the maximum coupling coefficient is a predetermined value CF_{TH} or smaller is also included in the candidates of the target power transmission-side coil.

More specifically, for example, when “n=6”, and (CF[1], CF[2], CF[3], CF[4], CF[5], CF[6])=(0.91, 0.85, 0.60, 0.53, 0.42, 0.27), and “CF_{TH}=0.1” are satisfied, because the CF[1] is the maximum coupling coefficient, the power transmission-side coil T_{L}[1] corresponding to CF[1] is included in the candidates of the target power transmission-side coil without any condition. CF[2] to CF[6] are the non-maximum coupling coefficients. A difference between CF[2] and the maximum coupling coefficient (CF[1]) is the predetermined value CF_{TH} or smaller, and hence the power transmission-side coil T_{L}[2] corresponding to CF[2] is also included in the candidates of the target power transmission-side coil. A difference between each of CF[3] to CF[6] and the maximum coupling coefficient (CF[1]) is larger than the predetermined value CF_{TH}, and hence the power transmission-side coils T_{L}[3] to T_{L}[6] corresponding to them are not included in the candidates of the target power transmission-side coil. As a result, the resonance circuit TT[1] including the power transmission-side coil T_{L}[1] as a candidate of the target power transmission-side coil and the resonance circuit TT[2] including the power transmission-side coil T_{L}[2] as a candidate of the target power transmission-side coil are extracted as candidates of the target resonance circuit (total two candidates).

In the value example described above, if “CF_{TH}=0.03” holds, candidates of the target power transmission-side coil is only the power transmission-side coil T_{L}[1], and hence the resonance circuit TT[1] including the power transmission-side coil T_{L}[1] is set as the target resonance circuit. In contrast, if two or more candidates of the target resonance circuit are extracted, the target resonance circuit setting process described above in the first embodiment is used, and the target resonance circuit is finally determined from the two or more candidates.

In other words, if two or more resonance circuits TT are extracted as candidates of the target resonance circuit, the received power value is acquired for each candidate by performing the process of Steps S32, S33, S42, and S43 (see FIG. 17) for each candidate, and one target resonance circuit is set by the transmission and reception of the power-related information (power-related information signal) based on the received power value acquired for each candidate.

More specifically, for example, if the resonance circuit TT[1] including the power transmission-side coil T_{L}[1] as a candidate of the target power transmission-side coil and the resonance circuit TT[2] including the power transmission-side coil T_{L}[2] as a candidate of the target power transmission-side coil are extracted as candidates of the target resonance circuit (total two candidates), it is sufficient to regard that “n” in Steps S34 and S44 in FIG. 17 is “2” so as to perform the process of FIG. 17. As a result, if the power-related information identifying that “PW[1]>PW[2]” holds is generated and acquired, the resonance circuit TT[1] is set as the target resonance circuit. If the power-related information identifying that “PW[1]<PW[2]” holds is generated and acquired, the resonance circuit TT[2] is set as the target resonance circuit.

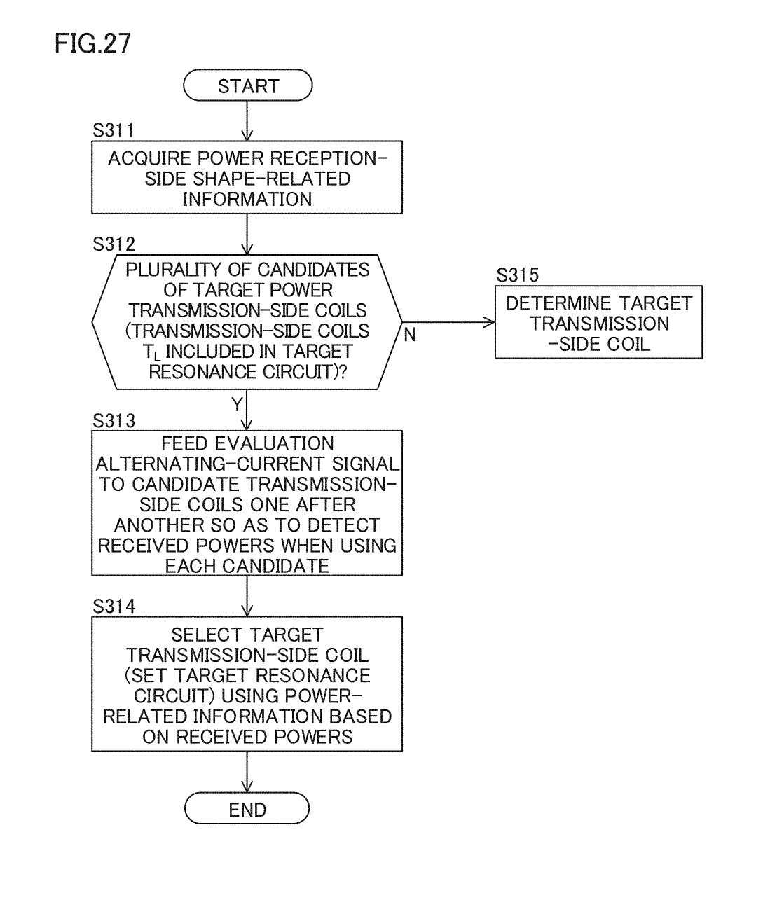

With reference to FIG. 27, the method described above can also be described as below.

The power feeding device 1 uses the target resonance circuit that is one of the resonance circuits TT[1] to TT[n] so as that the power transmission operation is performed. As described above, the power transmission-side coil T_{L} included in the target resonance circuit can be referred to as the target power transmission-side coil.

Also referring to the power transmission-side shape-related information appropriately, and based on the power reception-side shape-related information, the control circuit 160 selects one power transmission-side coil from the power transmission-side coils T_{L}[1] to T_{L}[n] as the target power transmission-side coil (Step S315 via Step S311 and N in Step S312) as a rule. The control circuit 160 may select two or more power transmission-side coils T_{L} from the power transmission-side coils T_{L}[1] to T_{L}[n] as candidates of the target power transmission-side coil (Step S311 and Y in Step S312).

When selecting two or more power transmission-side coils T_{L} as candidates of the target power transmission-side coil, the control circuit 160 controls the power transmission circuit 130 to feed the evaluation alternating-current signal to the two or more power transmission-side coils T_{L} one after another, so as to perform the test power transmission using the candidates individually (Step S313). The received powers of the power reception-side coils R_{L} when the two or more power transmission-side coils are supplied with the evaluation alternating-current signal are detected by the electronic device 2 (i.e. the received powers in the test power transmissions are individually detected) (Step S313). The power-related information based on the received power detected is transmitted to the power feeding device 1 by communication, and the control circuit 160 selects one target power transmission-side coil from two or more power transmission-side coils T_{L} as candidates of the target power transmission-side coil based on the acquired power-related information (Step S314). The resonance circuit TT including the selected target power transmission-side coil is set as the target resonance circuit. As described above in the first embodiment, the power-related information contains information that identifies the power transmission-side coil T_{L} corresponding to the maximum received power among the two or more received powers received by the power reception-side coil R_{L}, which is detected when the two or more power transmission-side coils T_{L} as candidates are individually supplied with the evaluation alternating-current signal.

### Fourth Embodiment

A fourth embodiment of the present invention is described. Some variations that can be applied to the first to third embodiments are described in the fourth embodiment.

Although the flow of transmitting and receiving the authentication signal 570 and the response signal 580 after the foreign object detection process before the power transfer is described above (see FIG. 19 etc.), the transmission and reception may be eliminated. In this case, the electronic device 2 starts to perform the f_{O} changing or short-circuiting operation at the transmission timing of the response signal 540, and uses the timer to measure the elapsed time from the transmission timing of the response signal 540. When the elapsed time reaches the predetermined period of time t_{M}, the f_{O} changing or short-circuiting operation is stopped, and the resonance circuit RR is connected to the power reception circuit 230. On the other hand, when receiving the response signal 540, the power feeding device 1 uses the timer to start to measure the elapsed time from the reception timing of the response signal 540, and starts to perform the foreign object detection process at the reception timing of the response signal 540. Further, when the measured elapsed time reaches the predetermined period of time t_{M}, a predetermined guard time is further waited, and then the power transfer 590 is started under condition that the foreign object absence determination is made. The value of the predetermined period of time t_{M} is determined so that the foreign object detection process is completed in the predetermined period of time t_{M}. The guard time is provided in consideration of a difference between measured time using the timer of the power feeding device 1 and measured time using the timer of the electronic device 2 and other factors.

In the embodiments described above, the plurality of power transmission-side resonance circuits TT used in the target resonance circuit setting process are completely identical to the plurality of power transmission-side resonance circuits TT used in the foreign object detection process, the present invention is not limited to this. The former plurality of power transmission-side resonance circuit TT may be partially identical to the latter plurality of power transmission-side resonance circuit TT. For example, if the target resonance circuit setting process is realized using the resonance circuits TT[1] to TT[n] as described above, the foreign object detection process may be performed using only the two or more resonance circuits TT included in the resonance circuits TT[1] to TT[n] as parts of the resonance circuits TT[1] to TT[n], among the resonance circuits TT[1] to TT[n] (e.g. using only the resonance circuits TT[1] and TT[2] under the condition of “n=3”).

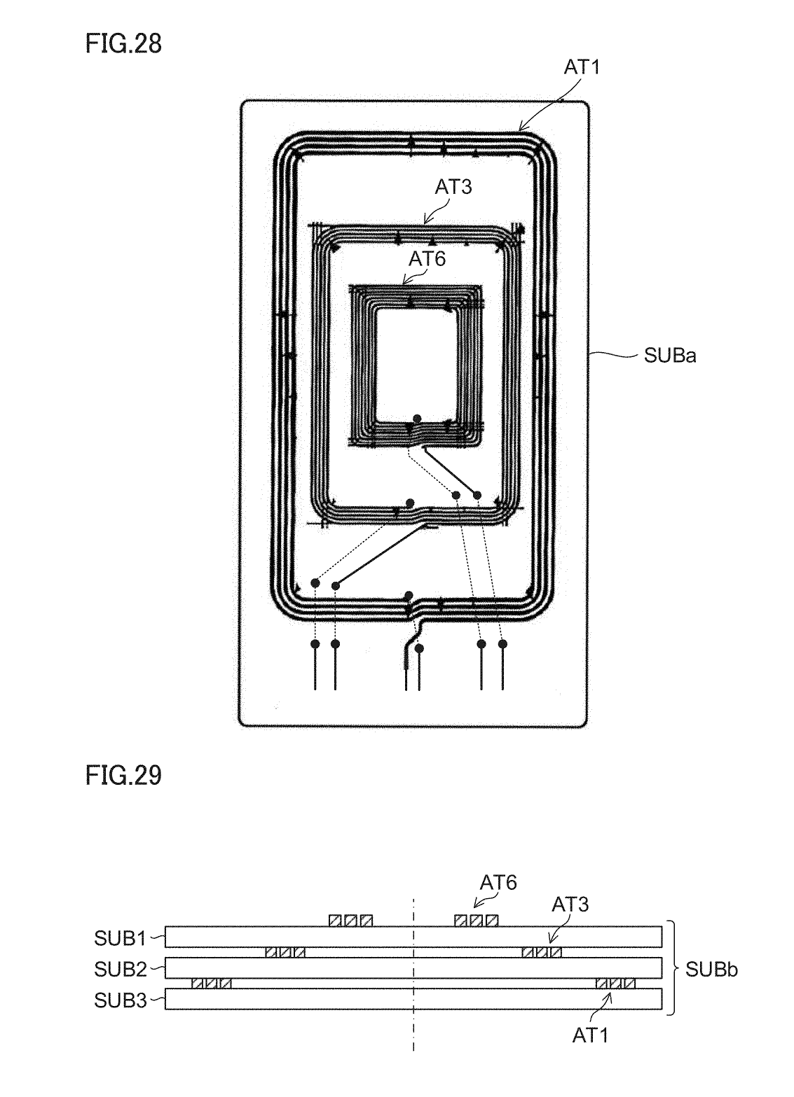

The plurality of power transmission-side coils T_{L} disposed in the power feeding device 1 may be disposed on the same surface. For example, when three power transmission-side coils T_{L} having the same shapes as the antenna coils AT1, AT3, and AT6 are disposed on the same surface as the power transmission-side coils T_{L}[1] to T_{L}[3], a first structure illustrated in FIG. 28 can be adopted. FIG. 28 is a schematic plan view of a single layer substrate SUBa according to the first structure.

Specifically, the antenna coils AT1, AT3, and AT6 are formed as three antenna patterns on the surface of the single layer substrate SUBa. Among the antenna coils AT1, AT3, and AT6, the antenna coil AT1 has the largest size, and the antenna coil AT6 has the smallest size. Therefore, on the surface of the substrate SUBa, the antenna pattern of the antenna coil AT3 is formed inside the antenna pattern of the antenna coil AT1, and further the antenna pattern of the antenna coil AT6 is formed inside the antenna pattern of the antenna coil AT3. Both ends of each antenna pattern are led out to the outside of the antenna pattern as the antenna coil AT1 (including the outside of the substrate SUBa), using through via holes formed in the substrate SUBa and patterns on a backside of the substrate SUBa.

Alternatively, the plurality of power transmission-side coils T_{L} disposed in the power feeding device 1 may be disposed on different surfaces. For example, when three power transmission-side coils T_{L} having the same shapes as the antenna coils AT1, AT3, and AT6 are disposed on three different surfaces as the power transmission-side coils T_{L}[1] to T_{L}[3], a second structure illustrated in FIG. 29 can be adopted. FIG. 29 is a schematic cross-sectional view of a multi-layered substrate SUBb according to the second structure.

Specifically, the multi-layered substrate SUBb constituted of a plurality of laminated substrates including three substrates SUB1 to SUB3 is disposed in the power feeding device 1 (the substrates are formed of resin material, but hatching is omitted in each substrate in the cross-sectional view of FIG. 29 to avoid complicated illustration). In this example, the substrate SUB1 is disposed on the uppermost layer, and the substrate SUB3 is disposed on the lowermost layer. Therefore, the substrate SUB2 is sandwiched between the substrate SUB1 and the substrate SUB3. Further, for example, the antenna pattern as the antenna coil AT3 is formed in a first internal layer formed between the substrates SUB1 and SUB2, the antenna pattern as the antenna coil AT1 is formed in a second internal layer formed between the substrates SUB2 and SUB3, and the antenna pattern as the antenna coil AT6 is formed in a layer on the substrate SUB1 corresponding to the uppermost layer of the multi-layered substrate SUBb (a pattern layer formed on one of surfaces of the substrate SUB1, the surface not facing the substrate SUB2). In this case, when viewing the antenna patterns from the direction perpendicular to the surfaces of the multi-layered substrate SUBb, the contour of the antenna pattern as the antenna coil AT3 is inside the contour of the antenna pattern as the antenna coil AT1, and the contour of the antenna pattern as the antenna coil AT6 is inside the contour of the antenna pattern as the antenna coil AT3. Although not illustrated in FIG. 29, both ends of each antenna pattern are led out to the outside of the antenna pattern as the antenna coil AT1 (including the outside of the substrate SUBb) using interlayer connection via holes (including through via holes and blind via holes) formed in the substrate SUBb and patterns in any layer (including the lower most layer) of the multi-layered substrate SUBb. Note that the antenna pattern arrangement illustrated in FIG. 29 is merely an example, and any antenna pattern can be formed in any layer.

### Consideration of the Present Invention

The present invention embodied by the above embodiments is considered.

A power transmission device W_{A1} according to one aspect of the present invention, which is the power transmission device (1) capable of communicating with the power reception device (2) equipped with the power reception-side coil and capable of transmitting electric power to the power reception device by magnetic resonance method, includes first to nth power transmission-side coils having different shapes (where n is an integer of 2 or more), the power transmission circuit (130) capable of feeding an alternating-current signal to one of the first to nth power transmission-side coils, and the control circuit (160) capable of performing power transmission operation to feed a power transmission alternating-current signal from the power transmission circuit to a target power transmission-side coil selected from the first to nth power transmission-side coils. Before performing the power transmission operation, the control circuit controls the power transmission circuit to feed an evaluation alternating-current signal to the first to nth power transmission-side coils one after another, acquires power-related information based on the received powers (PW[1] to PW[n]) by the power reception device when the evaluation alternating-current signal is fed to the first to nth power transmission-side coils, from the power reception device by communication, and selects the target power transmission-side coil from the first to nth power transmission-side coils based on the acquired power-related information.

In this way, high efficiency power transfer adapted to a shape or the like of the power reception-side coil can be performed.

Specifically, for example, in the power transmission device W_{A1}, the power-related information preferably contains information that identifies the power transmission-side coil corresponding to the maximum received power among the first to nth received powers by the power reception device based on the feeding of the evaluation alternating-current signal to the first to nth power transmission-side coils.

In addition, for example, in the power transmission device W_{A1}, before performing the power transmission operation, the control circuit preferably uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

In this way, it is possible to accurately detect whether or not a foreign object is present, which can have various shapes of coils (antenna coils), and it is possible to perform an appropriate power transmission control based on the detection result. Typically, for example, if it is determined that a foreign object is present, it is possible to control to prevent the power transmission from being performed, so that breakdown or the like of the foreign object can be avoided. In this case, the plurality of power transmission-side coils can be used for realizing both higher efficiency of the power transfer and higher accuracy of the foreign object detection.

In addition, for example, as to the power transmission device W_{A1}, the difference of shape includes a difference of size among the first to nth power transmission-side coils.

A non-contact power feeding system W_{A2} according to one aspect of the present invention includes the power transmission device W_{A1} described above and the power reception device equipped with the power reception-side coil, so that power transmission and reception can be performed by magnetic resonance method between the power transmission device and the power reception device.

In the non-contact power feeding system W_{A2}, for example, the power reception device includes the received power detection circuit (231) arranged to detect the received powers by the power reception-side coil when the evaluation alternating-current signal is fed to the first to nth power transmission-side coils, one after another, and the power-related information is preferably generated based on the detection result.

A power transmission device W_{B1} according to one aspect of the present invention is the power transmission device (1) capable of communicating with the power reception device (2) equipped with the power reception-side coil and capable of transmitting electric power to the power reception device by magnetic resonance method, including first to nth power transmission-side coils having different shapes (where n is an integer of 2 or more), the power transmission circuit (130) capable of feeding an alternating-current signal to one of the first to nth power transmission-side coils, and the control circuit (160) capable of performing power transmission operation to feed a power transmission alternating-current signal from the power transmission circuit to a target power transmission-side coil selected from the first to nth power transmission-side coils. Before performing the power transmission operation, the control circuit acquires shape-related information based on the shape of the power reception-side coil from the power reception device by communication, and selects the target power transmission-side coil from the first to nth power transmission-side coils based on the acquired shape-related information.

In this way, high efficiency power transfer adapted to a shape of the power reception-side coil can be performed.

For example, in the power transmission device W_{B1} (see the third embodiment), the control circuit can select two or more power transmission-side coils as candidates of the target power transmission-side coil from the first to nth power transmission-side coils based on the shape-related information. When the two or more power transmission-side coils are selected, the control circuit may control the power transmission circuit to feed an evaluation alternating-current signal to the two or more power transmission-side coils one after another, may acquire a power-related information based on the received powers by the power reception device when the evaluation alternating-current signal is fed to the two or more power transmission-side coils, from the power reception device by communication, and may select the target power transmission-side coil from the two or more power transmission-side coils based on the acquired power-related information.

In this way, the power transfer can be performed using the power transmission-side coil that can actually perform high efficiency based on the actual received power, though on the basis of the shape-related information.

In this case, in the power transmission device W_{B1}, the power-related information preferably contains information that identifies the power transmission-side coil corresponding to the maximum received power among two or more received powers by the power reception device based on the feeding of the evaluation alternating-current signal to the two or more power transmission-side coils.

In addition, for example, in the power transmission device W_{B1}, before performing the power transmission operation, the control circuit preferably uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

In this way, it is possible to accurately detect whether or not a foreign object is present, which can have various shapes of coils (antenna coils), and it is possible to perform an appropriate power transmission control based on the detection result. Typically, for example, if it is determined that a foreign object is present, it is possible to control to prevent the power transmission from being performed, so that breakdown or the like of the foreign object can be avoided. In this case, the plurality of power transmission-side coils can be used for realizing both higher efficiency of the power transfer and higher accuracy of the foreign object detection.

In addition, for example, as to the power transmission device W_{B1}, the difference of shape includes a difference of size among the first to nth power transmission-side coils.

A non-contact power feeding system W_{B2} according to one aspect of the present invention includes the power transmission device W_{B1} described above and the power reception device equipped with the power reception-side coil, so that power transmission and reception can be performed by magnetic resonance method between the power transmission device and the power reception device.

For example, in the non-contact power feeding system W_{B2}, the power reception device preferably includes a storage unit that stores the shape-related information.

A non-contact power feeding system W_{B3} according to one aspect of the present invention includes the power transmission device W_{B1} described above and the power reception device including the power reception-side coil, and is capable of power transmission and reception between the power transmission device and the power reception device by magnetic resonance method. The power reception device includes the storage unit that stores the shape-related information, and the received power detection circuit (231) that detects the received powers by the power reception-side coil when the evaluation alternating-current signal is fed to the two or more power transmission-side coils one after another, so as to generate the power-related information based on the detection result.

Note that the power feeding device 1 in each embodiment described above may function as the power transmission device according to the present invention, or a part of the power feeding device 1 in each embodiment described above may function as the power transmission device according to the present invention. In the same manner, the electronic device 2 in each embodiment described above may function as the power reception device according to the present invention, or a part of the electronic device 2 in each embodiment described above may function as the power reception device according to the present invention.

### Variations

The embodiments of the present invention can be variously modified appropriately within the scope of the technical concept described in the claims. The embodiments described above are merely examples of the embodiments of the present invention, and meanings of the present invention and the terms of the components thereof are not limited to those described in the embodiments. The specific values described in the above description are merely examples, which can be changed to various values as a matter of course. As annotations that can be applied to the embodiments described above, Note 1 to Note 3 are described below. Contents described in the notes can be arbitrarily combined as long as no contradiction occurs.

[Note 1]

In the embodiments described above, the frequencies of various signals and the resonance frequency are set to 13.56 MHz as the reference frequency, but 13.56 MHz is a setting target value, and the frequencies in actual devices have errors.

[Note 2]

In the embodiments described above, the present invention is embodied according to the NFC standard, and hence the reference frequency is 13.56 MHz. However, the reference frequency may be a frequency other than 13.56 MHz. In relation to this, the present invention may be applied to communication and power transfer between the power feeding device and the electronic device according to a standard other than the NFC.

[Note 3]

A target device as the power reception device or the power transmission device according to the present invention can be constituted of hardware such as an integrated circuit or a combination of hardware and software. All of the functions realized by the target device or a part of the functions, i.e. any particular function may be described as a program, and the program may be stored in a flash memory mountable in the target device. Further, the program may be executed by a program execution device (e.g. a microcomputer mountable in the target device) so that the particular function can be realized. The program can be stored and fixed in an arbitrary recording medium. The recording medium that stores and fixes the program may be mounted in or connected to a device other than the target device (such as a server device).

What is claimed is:

1. A power transmission device capable of communicating with a power reception device equipped with a power reception-side coil and capable of transmitting electric power to the power reception device by magnetic resonance method, the power transmission device comprising:
first to nth power transmission-side coils having different shapes (where n is an integer of 2 or more);
a power transmission circuit capable of feeding an alternating-current signal to one of the first to nth power transmission-side coils; and
a control circuit capable of performing power transmission operation to feed a power transmission alternating-current signal from the power transmission circuit to a target power transmission-side coil selected from the first to nth power transmission-side coils, wherein
before performing the power transmission operation, the control circuit controls the power transmission circuit to feed an evaluation alternating-current signal to the first to nth power transmission-side coils one after another, acquires power-related information based on the received powers by the power reception device when the evaluation alternating-current signal is fed to the first to nth power transmission-side coils, from the power reception device by communication, and selects the target power transmission-side coil from the first to nth power transmission-side coils based on the acquired power-related information.

2. The power transmission device according to claim 1, wherein the power-related information contains information that identifies a power transmission-side coil corresponding to a maximum received power among the first to nth received powers by the power reception device based on the feeding of the evaluation alternating-current signal to the first to nth power transmission-side coils.

3. The power transmission device according to claim 1, wherein before performing the power transmission operation, the control circuit uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

4. The power transmission device according to claim 1, wherein the difference of shape includes a difference of size among the first to nth power transmission-side coils.

5. A non-contact power feeding system comprising the power transmission device according to claim 1, and a power reception device equipped with a power reception-side coil, so that power transmission and reception can be performed by magnetic resonance method between the power transmission device and the power reception device.

6. The non-contact power feeding system according to claim 5, wherein the power reception device includes a received power detection circuit arranged to detect the received powers by the power reception-side coil when the evaluation alternating-current signal is fed to the first to nth power transmission-side coils, one after another, and the power-related information is generated based on the detection result.

7. A power transmission device capable of communicating with a power reception device equipped with a power reception-side coil and capable of transmitting electric power to the power reception device by magnetic resonance method, the power transmission device comprising:
first to nth power transmission-side coils having different shapes (where n is an integer of 2 or more);
a power transmission circuit capable of feeding an alternating-current signal to one of the first to nth power transmission-side coils; and
a control circuit capable of performing power transmission operation to feed a power transmission alternating-current signal from the power transmission circuit to a target power transmission-side coil selected from the first to nth power transmission-side coils, wherein
before performing the power transmission operation, the control circuit acquires shape-related information based on shape of the power reception-side coil from the power reception device by communication, and selects the target power transmission-side coil from the first to nth power transmission-side coils based on the acquired shape-related information.

8. The power transmission device according to claim 7, wherein
the control circuit is capable of selecting two or more power transmission-side coils as candidates of the target power transmission-side coil from the first to nth power transmission-side coils based on the shape-related information, and
when the two or more power transmission-side coils are selected, the control circuit controls the power transmission circuit to feed an evaluation alternating-current signal to the two or more power transmission-side coils one after another, acquires a power-related information based on the received powers by the power reception device when the evaluation alternating-current signal is fed to the two or more power transmission-side coils, from the power reception device by communication, and selects the target power transmission-side coil from the two or more power transmission-side coils based on the acquired power-related information.

9. The power transmission device according to claim 8, wherein the power-related information contains information that identifies a power transmission-side coil corresponding to a maximum received power among two or more received powers by the power reception device based on feeding of the evaluation alternating-current signal to the two or more power transmission-side coils.

10. The power transmission device according to claim 7, wherein before performing the power transmission operation, the control circuit uses the plurality of power transmission-side coils included in the first to nth power transmission-side coils to detect whether or not a foreign object is present, which generates current based on the magnetic field generated by the power transmission-side coil included in the first to nth power transmission-side coils, so that the power transmission operation is performed or not performed based on the detection result.

11. The power transmission device according to claim 7, wherein the difference of shape includes a difference of size among the first to nth power transmission-side coils.

12. A non-contact power feeding system comprising the power transmission device according to claim 7, and a power reception device equipped with a power reception-side coil, so that power transmission and reception can be performed by magnetic resonance method between the power transmission device and the power reception device.

13. The non-contact power feeding system according to claim 12, wherein the power reception device includes a storage unit that stores the shape-related information.

14. A non-contact power feeding system comprising the power transmission device according to claim 8, and a power reception device equipped with a power reception-side coil, so that power transmission and reception can be performed by magnetic resonance method between the power transmission device and the power reception device, wherein
the power reception device includes a storage unit that stores the shape-related information, and a received power detection circuit arranged to detect the received powers by the power reception-side coil when the evaluation alternating-current signal is fed to the two or more power transmission-side coils, one after another, and the power-related information is generated based on the detection result.
